(19) United States
(12) Patent Application Publication
(10) Pub. No.: US 2026/0361024 A1
(43) Pub. Date: Nov. 12, 2026

(54) HIGH CURRENT ELECTRICAL CONNECTOR WITH IMPROVED HANDLING

(71) Applicant: Amphenol Corporation, Wallingford, CT (US)

(72) Inventors: Yilin Liu, Dongguan (CN); Yulin Rao, Dongguan City (CN); Steven E. Pressel, Hazleton, PA (US); Shyam Xavier, Kochi (IN)

(73) Assignee: Amphenol Corporation, Wallingford, CT (US)

(21) Appl. No.: 19/718,716

(22) Filed: Jun. 24, 2026

Related U.S. Application Data
(63) Continuation of application No. PCT/CN2024/116789, filed on Sep. 4, 2024.
Application No. PCT/CN2024/116789 is a continuation-in-part of application No. 29/923,325, filed on Dec. 28, 2023, now Pat. No. D1094296.
Application No. 29/923,325 is a continuation-in-part of application No. 29/923,355, filed on Dec. 28, 2023, now Pat. No. D1131396.
Application No. 29/923,355 is a continuation-in-part of application No. 29/923,332, filed on Dec. 28, 2023, now Pat. No. D1096640.
Application No. 29/923,332 is a continuation-in-part of application No. 29/923,328, filed on Dec. 28, 2023, now Pat. No. D1108373.
Application No. 29/923,328 is a continuation-in-part of application No. 29/923,346, filed on Dec. 28, 2023, now Pat. No. D1128596.
Application No. 29/923,346 is a continuation-in-part of application No. 29/923,361, filed on Dec. 28, 2023, now Pat. No. D1128597.

(51) Int. Cl. H01R 13/53; H01R 13/631

(52) U.S. Cl. CPC H01R 13/53; H01R 13/631

(57) ABSTRACT

A high current electrical connection system with a plug and receptacle can be quickly and reliably connected or disconnected and simply assembled or disassembled for repair. Such connection systems may be used in applications requiring multiple connections that can be quickly made or broken, such as grid scale battery facilities. The electrical connection system may have features that enable easy, one-handed latching and/or unlatching of plug and receptacle connectors. Operation of the latch may ensure that the plug and receptacle are fully and reliably mated. Alternatively or additionally, one or both of the connectors may include features that provide visual, audible and/or tactile feedback when the connectors are reliably engaged. The plug and/or receptacle connectors may include features that enable power and/or signal terminals to be easily installed or removed from the connector housings, such that the housing or the terminals can be easily replaced, even in the field.

### BACKGROUND

High current electrical connectors are becoming more common due to increased electrification. These connectors are commonly used in applications including making connections to electric vehicles for charging their batteries, connecting multiple batteries in energy storage facilities, and other applications requiring high current. High current connectors, sometimes called power connectors, may be damaged as they are used in these applications. Such damage can be costly because of the cost to repair or replace the connector as well as because of the loss of use of the equipment to which electrical connections are inhibited while the high current electrical connectors are being repaired or replaced.

### BRIEF SUMMARY

Concepts as disclosed herein may be embodied as an electrical connector configured to support a high current. The electrical connector may comprise an electrically conductive terminal configured as a power terminal and comprising a mating portion; and an insulative housing. The insulative housing may comprise a cavity; a first wall bounding the cavity, the first wall comprising a first hole; a first opening into the cavity, the first opening sized for the electrically conductive terminal to pass through the first opening into the cavity during assembly; and a second opening into the cavity. The mating portion of the electrically conductive terminal may be disposed within the cavity and accessible through the second opening. The insulative housing may also comprise a signal conductor assembly comprising a plurality of signal terminals and a signal conductor carrier supporting the plurality of signal terminals. The signal conductor carrier may comprise a compliant portion configured to engage with a feature of the insulative housing.

Alternatively or additionally, concepts as disclosed herein may be embodied as an electrical connector, configured to support a high current. The electrical connector may comprise an electrically conductive terminal comprising a mating portion and a first positioning notch; and an insulative housing. The insulative housing may comprise a cavity; a first wall bounding the cavity, the first wall comprising a first hole; a first opening into the cavity, the first opening sized for the electrically conductive terminal to pass through the first opening into the cavity during assembly; and a second opening into the cavity. The mating portion of the electrically conductive terminal may be disposed within the cavity and accessible through the second opening. The insulative housing may also comprise a retaining member comprising a portion disposed within the first hole and may be removably held within the cavity. The retaining member may comprise a first compliant portion engaging with the first wall of the insulating housing, such that the retaining member may be removably secured at the first wall, the first compliant portion being configured to be deflected to disengage with the first wall; and a retaining portion engaging the first positioning notch of the electrically conductive terminal, such that the terminal may be secured within the cavity of the insulative housing. The retaining portion may be configured to be disengaged from the positioning notch of the electrically conductive terminal such that the electrically conductive terminal is removable from the insulative housing though the first opening.

Alternatively or additionally, concepts as disclosed herein may be embodied as a method for assembling an electrical connector. The method may comprise inserting one or more electrically conductive terminals into a housing through a first opening in the housing such that mating portions of the one or more terminals are exposed through respective openings in the housing, different from the first opening; inserting one or more retaining members into the housing such that the retaining members are removably secured at a wall of the housing by compliant portions of the one or more retaining members that engage with the wall of the housing, and the retaining members engage one or more positioning notches of each of the one or more electrically conductive terminals such that the terminals are secured within the housing; and inserting a signal conductor assembly through the first opening of the housing such that a compliant portion of the signal conductor assembly is engaged by an interior edge of the housing and the signal conductor assembly is removably secured within the housing.

Alternatively or additionally, concepts as disclosed herein may be embodied as an electrical connection system. The electrical connection system may comprise a first connector; and a second connector. The first connector may comprise a first electrically conductive terminal; and a first insulative housing. The first insulative housing may comprise a first mating interface comprising a first opening exposing an end of the electrically conductive terminal; and a latch rotatably coupled to the housing and configured to rotate between a first position and a second position. The latch may comprise a first end comprising a race with an opening into the race and a second end comprising an actuator. The latch may be rotatably coupled to the housing between the first end and the second end of the latch. The second connector may comprise an insulative receptacle housing. The insulative receptable housing may comprise an exterior protrusion comprising a first portion and a second portion, wider than the first portion; and a second mating interface configured to mate with the first mating interface of the first connector; and a second electrically conductive terminal configured to electrically connect with the first electrically conductive terminal, when the latch is in the second position with the exterior protrusion within the race. The latch may be configured such that when the first connector and second connector are pushed together with the latch in the first position, the second portion of the exterior protrusion may be aligned with the opening into the race.

Alternatively or additionally, concepts as disclosed herein may be embodied as a first electrical connector, configured to support a high current and configured to mate with a second electrical connector comprising hooked protrusions. The first electrical connector may comprise a plurality of electrically conductive terminals; and an insulative housing. The insulative housing may comprise a mating interface comprising a plurality of openings exposing respective ends of the plurality of electrically conductive terminals; and a first and a second channel positioned on a respective first and second side of the mating interface, configured to receive the hooked protrusions of the second electrical connector; and a latch configured to secure the first connector to the second connector. The latch may comprise an actuator slidably mounted to the insulative housing, the actuator comprising first and second hooks positioned within the first and second channels; and a spring between the actuator and the insulative housing, the spring biasing the actuator away from a surface of the insulative housing.

Alternatively or additionally, concepts as disclosed herein may be embodied as a first electrical connector, configured to support a high current and configured to mate with a second electrical connector comprising an exterior protrusion comprising a first portion and a second portion, wider than the first portion. The first electrical connector may comprise a first electrically conductive terminal; and a first insulative housing. The first insulative housing may comprise a first mating interface comprising a first opening exposing an end of the electrically conductive terminal; and a latch rotatably coupled to the housing and configured to rotate between a first position and a second position. The latch may comprise a first end comprising a race with an opening into the race and a second end comprising an actuator. The latch may be rotatably coupled to the housing between the first end and the second end of the latch. The latch may be configured such that when the first connector and second connector are pushed together with the latch in the first position, the second portion of the exterior protrusion of the second connector may be aligned with the opening into the race.

Alternatively or additionally, concepts as disclosed herein may be embodied as an electrical connector. The electrical connector may comprise an electrically conductive terminal comprising a mating portion and a first positioning notch. The mating portion may comprise a planar blade. The electrical connector may also comprise an insulative housing. The insulative housing may comprise a cavity; a first wall bounding the cavity, the first wall comprising a first hole; a first opening into the cavity, the first opening sized for the electrically conductive terminal to pass through the first opening into the cavity during assembly; and a second opening into the cavity. The mating portion of the electrically conductive terminal may be disposed within the cavity and accessible through the second opening; and a retaining member comprising a portion disposed within the first hole and may be removably held within the cavity. The retaining member may comprise a first compliant portion engaging with the first wall of the insulating housing, such that the retaining member may be removably secured at the first wall, the first compliant portion being configured to be deflected to disengage with the first wall; and a retaining portion engaging with the first positioning notch of the electrically conductive terminal, such that the terminal may be secured within the cavity of the insulative housing. The retaining portion may be configured to be disengaged from the positioning notch of the electrically conductive terminal, such that the electrically conductive terminal may be removed from the insulative housing though the first opening.

These techniques may be used alone or in any suitable combination. The foregoing summary is provided by way of illustration and is not intended to be limiting.

### BRIEF DESCRIPTION OF DRAWINGS

Various aspects of at least one embodiment are discussed herein with reference to the accompanying figures. The figures are included to provide illustration and a further understanding of the various aspects and embodiments and are incorporated in and constitute a part of this specification but are not intended as a definition of the limits of the invention. Where technical features in the figures, detailed description or any claim are followed by reference signs, the reference signs have been included for the sole purpose of increasing the intelligibility of the figures, detailed description, and/or claims. Accordingly, neither the reference signs nor their absence is intended to have any limiting effect on the scope of any claim element. In the figures, each identical or nearly identical component that is illustrated in various figures is represented by a like numeral. For purposes of clarity, not every component may be labeled in every figure. In the figures:

FIG. 1 is a perspective view of an example alternative embodiment of a high current electrical connection system with mated plug and receptacle connectors each with multiple terminal assemblies, according to some embodiments of the technology described herein.

FIG. 2A is a front perspective view of the example receptacle connector of the electrical connection system of FIG. 1.

FIG. 2B is a front view of the receptacle connector of FIG. 2A.

FIG. 2C is a perspective view of the receptacle connector of FIG. 2A, with the housing hidden to reveal internal components of the receptacle connector.

FIG. 2D is a view of a terminal assembly of the example receptacle connector of FIG. 2A.

FIG. 3A is a front perspective view of the example plug connector of the electrical connection system of FIG. 1.

FIG. 3B is a front view of the example plug connector of FIG. 3A.

FIG. 3C is a perspective view of the example plug connector of FIG. 3A with the housing hidden to reveal internal components of the plug connector.

FIG. 3D is a perspective view of a terminal assembly of the example plug connector of FIG. 3A.

FIGS. 4A-4C are side views the electrical connection system of FIG. 1 during successive steps in an example mating process.

FIG. 5A is a perspective view of an exemplary high current electrical connection system with a two point locking of a latch, according to some embodiments of the technology described herein.

FIG. 5B is a perspective view of the plug connector, with the latch removed, of the high current electrical connection system of FIG. 5A.

FIG. 5C is a schematic sectional view through the locking feature of the high current electrical connection system of FIG. 5A in a disengaged position.

FIG. 5D is a sectional view through the locking feature of the high current electrical connection system of FIG. 5A in an engaged position.

FIG. 6A is a perspective view of a plug connector of an alternative embodiment of a high current electrical connection system with a spring locking latch.

FIG. 6B is a perspective view of the plug connector of FIG. 6A, with the latch removed.

FIG. 6C is a sectional view of a locking feature of the plug connector of FIG. 6A in a disengaged position.

FIG. 6D is a sectional view of a locking feature of the plug connector of FIG. 6A in an engaged position.

FIG. 7A is a perspective view of an alternative embodiment of a high current electrical connection system with a latch having an actuator latch mechanism, according to some embodiments of the technology described herein.

FIG. 7B is a perspective view the high current electrical connection system of FIG. 7A with the plug connector and receptacle connectors separated, such as may occur during a mating or unmating process.

FIG. 7C is a perspective view of the receptacle connector of the high current electrical connection system of FIG. 7A.

FIG. 7D is a perspective view of the plug connector of the high current electrical connection system of FIG. 7A.

FIG. 7E is a perspective view of the plug connector of FIG. 7D with the actuator hidden to reveal springs.

FIG. 7F is a perspective view of the plug connector of FIG. 7E, with the springs removed to reveal spring mounting locations on the plug housing.

FIG. 7G is a perspective view of the actuator of the plug connector of FIG. 7D.

FIG. 7H is an enlarged side perspective view of the latch of the high current electrical connection system of FIG. 7A with the plug and receptacle connectors connected.

FIG. 7I to 7K are sectional views of the actuator of FIG. 7A and complementary latching structures of a receptacle connector at successive steps in a process of mating the plug and receptacle connectors of the high current electrical connection system of FIG. 7A, with FIG. 7I showing the latching structures in an unlatched position, FIG. 7J showing the latching structures transitioning to a latched position, and FIG. 7K showing the latching structures in the latched position.

FIG. 7L is a top view of the high current electrical connection system of FIG. 7A with a locking feature in an engaged position.

FIG. 7M is a top view of the high current electrical connection system of FIG. 7A with a locking feature in a disengaged position.

FIG. 8A is an exploded, top perspective view of a receptacle connector of the high current electrical connection system of FIG. 7A, with retaining members removed from the connector housing.

FIG. 8B is a bottom perspective view of the receptacle connector of the high current electrical connection system of FIG. 8A.

FIG. 8C is a sectional view through a retaining member of the receptacle connector of FIG. 8A.

FIG. 8D is a top perspective view of the housing of the receptacle connector of FIG. 8A, partially cut away.

FIG. 8E is a top view of the receptacle connector of FIG. 8A, with the housing hidden to reveal terminal assemblies.

FIG. 8F is a side view of terminal assemblies and a retaining member of FIG. 8E.

FIG. 8G is a partially exploded perspective view of the receptacle connector of FIG. 8A, schematically illustrating an assembly process for the receptacle connector.

FIG. 9A is a top perspective view of a plug connector configured to mate with the receptacle connector of FIG. 8A to form a high current electrical connection system, with retaining members removed from the connector housing.

FIG. 9B is a bottom perspective view of the plug connector of FIG. 9A.

FIG. 9C is a sectional view through a retaining member of the plug connector FIG. 9A.

FIG. 9D is a top perspective view of the housing of the plug connector of FIG. 9A, partially cut away.

FIG. 9E is a top view of the plug connector of FIG. 9A, with the housing hidden to reveal terminal assemblies.

FIG. 9F is a side view of terminal assemblies and a retaining member of the plug connector of the high current electrical connections system of FIG. 9E.

FIG. 9G is a partially exploded perspective view of the plug connector of FIG. 9A, schematically illustrating an assembly process for the plug connector.

FIG. 10A is a sectional view of a portion of the plug connector of FIG. 9A through central conductors of a signal conductor subassembly, according to some aspects of the technology described herein.

FIG. 10B is a sectional view of a portion of the receptacle connector of FIG. 8A through peripheral conductors of a signal conductor subassembly, according to some aspects of the technology described herein.

FIG. 10C is a sectional view of a portion of the plug connector of FIG. 9A through peripheral conductors of a signal conductor subassembly, according to some aspects of the technology described herein.

FIG. 10D is a perspective view of the signal conductor assembly of the receptacle connector of FIG. 8A.

FIG. 10E is a perspective view of the signal conductor assembly of the plug connector of FIG. 9A.

FIG. 10F is a rear perspective view of an housing of the receptacle connector of FIG. 8A, with a signal conductor assembly positioned for insertion.

FIG. 10G is a rear perspective view of the housing of the plug connector of FIG. 9A with a signal conductor assembly positioned for insertion.

### DETAILED DESCRIPTION

The inventors have recognized and appreciated designs that increase serviceability and simplify handling of high current electrical connectors. These techniques may be used alone or in combination in any of multiple connector configurations to support applications where serviceability and/or simplified connector handling is advantageous.

The inventors have recognized and appreciated that in some applications, high current connectors may be connected and disconnected frequently, and it is desirable to have connectors which can be efficiently and conveniently operated such that components may be quickly and reliably connected or disconnected in an electrical system. In some applications, such as large scale batteries and energy storage applications, hundreds or thousands of high current connections may be required. In such applications, especially during assembly or maintenance, it is desirable to have reliable connectors that can be efficiently operated.

Accordingly, aspects of the technology described herein provide a high-current electrical connector with improved handling. Some such connectors may include latch mechanisms that, when engaged, promote reliable connections through mated connectors. Some latching mechanisms may be operated easily, such as by enabling a user to mate or unmate connectors using only one hand or by providing visual, audible and/or tactile feedback for a user that the connectors are properly mated and latched. Optionally, the latch mechanism may be configured to automatically engage when the plug connector of the connector is inserted into the receptacle connector of the connector. Optionally, the latch mechanism may be configured to allow a user to complete the connection by using a single hand. Optionally, the latch mechanism may include a latch that may be operated to secure the plug connector to the receptacle connector. Optionally, the latch mechanism may include an actuator, which may be operated to disengage the plug connector from the receptacle connector. Optionally, the latch mechanism may provide a visual indication that the plug connector is properly secured to the receptacle connector. In some examples, the latch mechanism provides a tactile indication that the plug connector of the connector is properly secured to the receptacle connector.

In another aspect, increased serviceability allows connectors to be maintained without requiring complete replacement of damaged connectors. Techniques as described herein may enable servicing of connectors and may be simple enough that the connectors can be maintained in the field. Increased serviceability reduces costs and system downtime, particularly for connectors used in environments in which there is a high incidence of damage.

Electrical connectors may be damaged in any of multiple ways, such as because of contamination by dirt, water, moisture, or dust; improper use of the connector; large forces applied to the connector; or repeated use of the connector over time. When power connectors are damaged, equipment intended to be powered through the connector is often rendered inoperable. In applications such as energy storage, for example, damage to a connector may prevent energy from being transferred either into or out of storage. Accordingly, quick and efficient repair of damaged connectors may be important.

Techniques as described herein may facilitate repairing electrical connectors without replacing a full electrical connector, avoiding repairs that might otherwise be expensive and time consuming. Techniques as described herein, for example, may enable a single terminal assembly of an electrical connector to be replaced, while leaving power or other terminal assemblies, a connector housing and other components of the connector. Alternatively, a damaged housing of a connector might be replaced with a new housing, reusing terminal assemblies, which may already be terminated to cables.

To support serviceability, an electrical connector may include modular components. The modular components may include individual components of the connector or assemblies of multiple components of the connectors. The modular components may be assembled together to form the electrical connector or a portion of the electrical connector. The modular components may be removed from the connector and replaced with new components during servicing or repair of the connector. The inventors have appreciated that the use of modular components allows connectors to be repaired without requiring replacement of the connector, which allows connectors to be repaired faster and at lower cost, as all components of the connector are not required to be repaired or replaced.

In some examples, components of an electrical connector may be secured within a housing of the electrical connector with one or more retaining members. The retaining members may interact with the housing of the electrical connector to secure the components of the connector. For example, the retaining members may engage with the housing. Optionally, the retaining members may engage with the housing via a snap fit connection. Optionally, the retaining members include a compliant portion which engages with a feature of the housing. Optionally, the retaining members may engage with one or more holes in the housing. Optionally, the retaining members may be disengaged from the housing to facilitate removal of the components secured within the housing.

In some examples, components of the electrical connectors may be assembled within a carrier. The carrier may be used to secure the components of the electrical connector within the housing. Optionally, the carrier engages with the housing. Optionally, the carrier includes compliant portions which engage with the housing. Optionally, the compliant portions of the carrier may engage with one or more retaining edges of the housing. Optionally, the carrier may be disengaged from the housing to facilitate removal of the carrier and components secured within the housing.

One or more techniques as described herein may be used in high current electrical connectors. In some examples, high current electrical connectors are configured to support at least 200 A of current, at least 300 A, at least 350 A, at least 400 A, at least 500 A, at least 600 A, at least 700 A, at least 1000 A, 200-800 A, or 350-700 A of current.

Connectors as described herein may include power terminals. The receptacle connector may include power terminals configured to engage with corresponding power terminals of the plug connector and vice versa. Power terminals may be sized and shaped to support the transfer of high current. In some examples, an electrical connector may be capable of receiving multiple power terminals, some or all of which may be installed to provide a desired current carrying capacity of the connector.

In some examples, the contacts of the electrical terminals may be stamped contacts. Stamped contacts for high current electrical connectors provide advantages over conventional machined pin/socket terminals, as the stamped contacts may be produced at a lower cost than conventional terminals and allow for termination to a greater number of wire or cable sizes and quantities than conventional terminals.

Connectors as described herein may include signal conductors. In some examples, the receptacle connector may include signal conductors configured to engage with corresponding signal conductors of the plug connector. Signal conductors may support the transfer of data or control signals, but may be smaller than power terminals as they may carry less current. In some examples, an electrical connector may include multiple signal conductors integrated into a signal conductor assembly, which may be installed or removed from the connector as a unit.

Techniques as described herein may facilitate connectors that can be operated by a human user with a single hand, which allows for efficient and effective operation of the connector. A latch mechanism as described herein may enable single handed operation because of the automatic engagement of the latch mechanisms when a proper connection is formed. This capability provides benefits in applications, such as in energy storage, where multiple connectors are used or in applications where connections are frequently made and disengaged, such as in electrical vehicles. Techniques as described herein may also enable visual, tactile, and/or auditory indicators that a proper connection has been made, allowing for effective connections to be made with minimal errors and for efficient confirmation of connections.

Electrical connectors as described herein may have modular and removable components, which enables efficient assembly, repair and/or replacement of components of an electrical connection system. By providing components that may be engaged from the exterior of the housing, such as retaining members and carriers as described herein, components such as terminal assemblies and signal conductor assemblies may be easily installed or removed from electrical connection systems. This capability may facilitate efficient and rapid repair of a single damaged component or subset of components of electrical connection systems that have been damaged. For example, a single terminal may be removed from a connector and replaced with a new terminal. This capability reduces the costs of maintenance of the electrical connection system and allows for faster replacement of components.

In addition, providing modular components such as the terminal assemblies and signal conductor assemblies increases the efficiency for assembling and replacing components by reducing the work required to replace individual components. For example, by providing signal conductor assemblies pre-assembled with conductors and wires, a broken conductor may quickly be repaired by removing the signal conductor assembly with the broken conductor and inserting a new signal conductor assembly. Such a repair may be faster than comparable repairs for conventional connectors that do not include signal conductor assemblies. Alternatively or additionally, removing the signal conductor assembly may provide better access to the damaged conductor such that it may be more easily replaced.

Techniques as described herein may be applied separately or in combination in any of multiple types of high current connectors, a subset of which are described herein as examples of these techniques

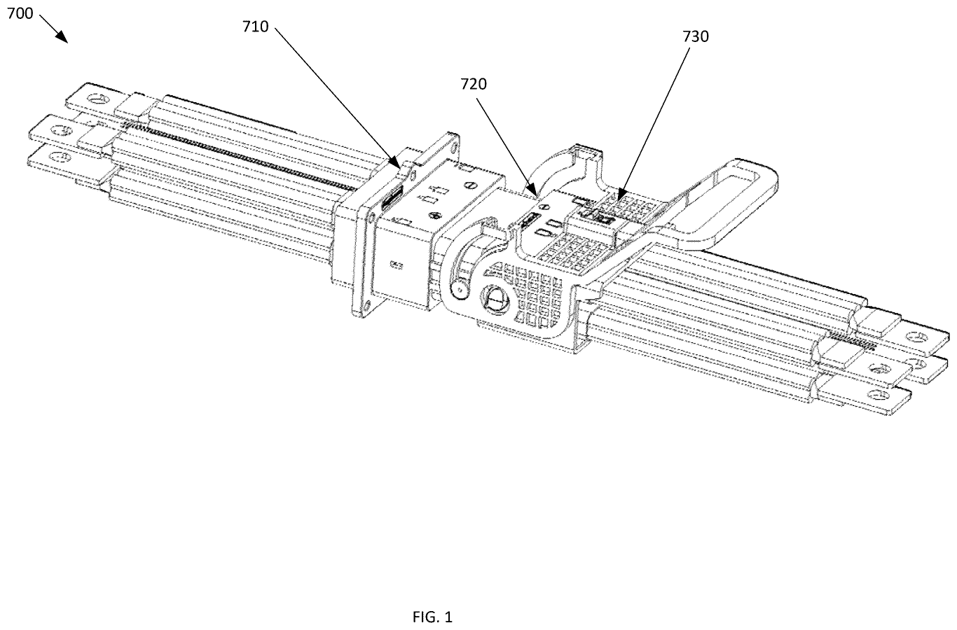

Example implementations of such techniques are provided in the embodiments shown in the drawings. FIG. 1 is a perspective view of an example of a high current electrical connection system with features that enable the electrical connection system to be easily operated and easily maintained. Electrical connection system 700 includes mated plug and receptacle connectors each with multiple terminal assemblies, according to some embodiments of the technology described herein. As shown, the electrical connection system 700 includes four terminals, however it may include more or fewer terminals. For example, the electrical connection system 700 may include one terminal, two terminals, three terminals, five terminals, six terminals, four to ten terminals, or greater than ten terminals. As shown, the terminals of electrical connection system 700 are arranged in two rows of two terminals, however other arrangements may be used, for example, a single row of terminals, a single column of terminals, or rows or columns of terminals with varying numbers of terminals.

Electrical connection system 700 includes receptacle connector 710 and plug connector 720. Also shown is latch mechanism 730. Latch mechanism 730 is a rotating latch mechanism, however other latch mechanisms may be used with the electrical connection system 700.

The connection system 700 in FIG. 1 may be used, for example, in a grid storage application. In that application, receptacle connector 710 may be attached to one terminal of a battery (not shown). Plug connector 720 may be attached to a terminal of another battery. In this way, by mating the plug and receptacle connectors, the batteries may be connected to provide a higher voltage of a higher current connection to the grid storage system. Though only one such connection is shown, in such an application, there may be multiple batteries that are interconnected, resulting in a large number of connections.

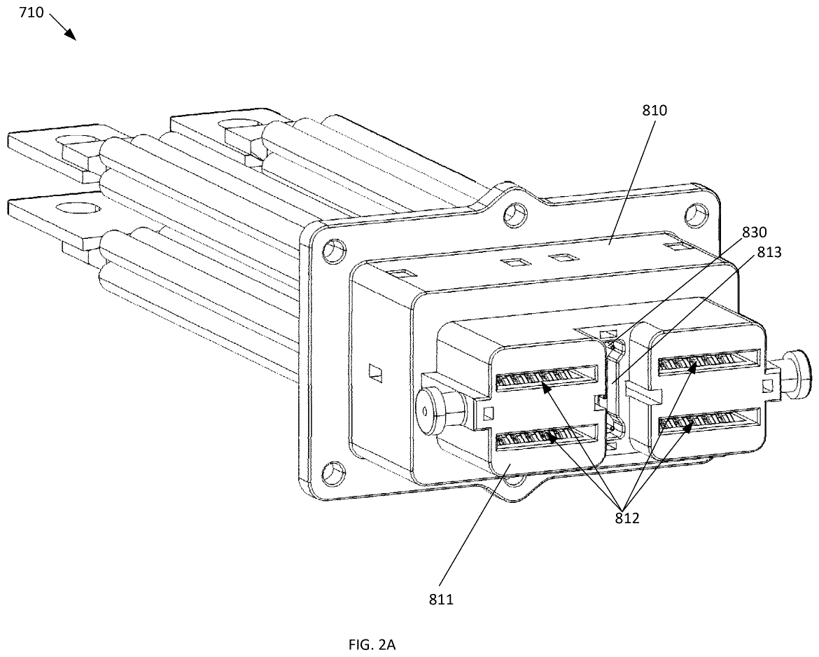

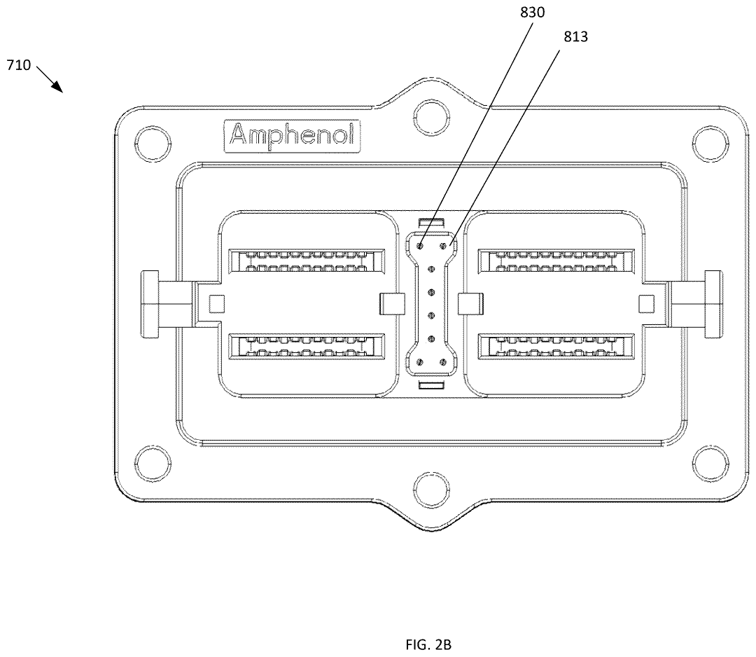

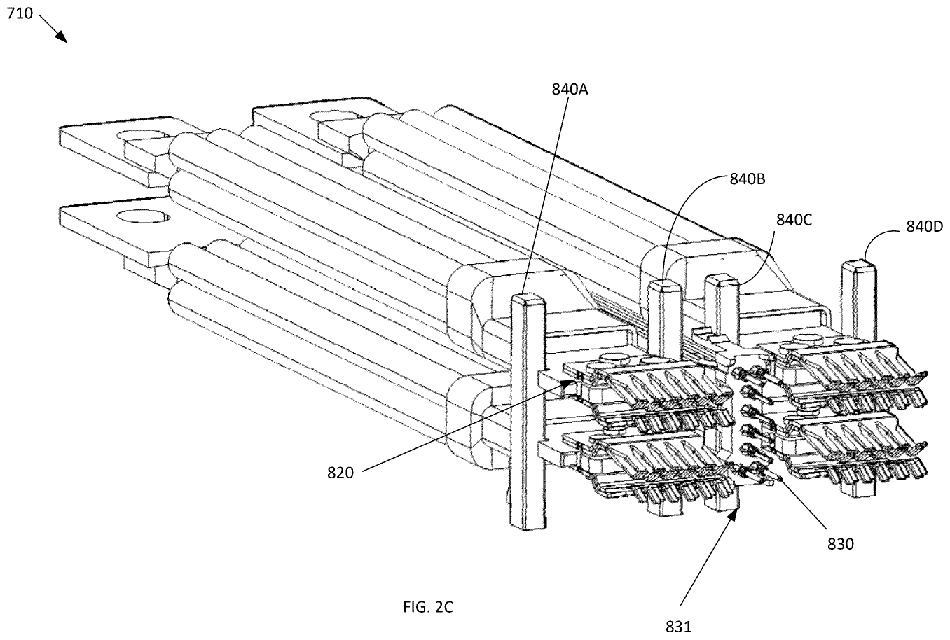

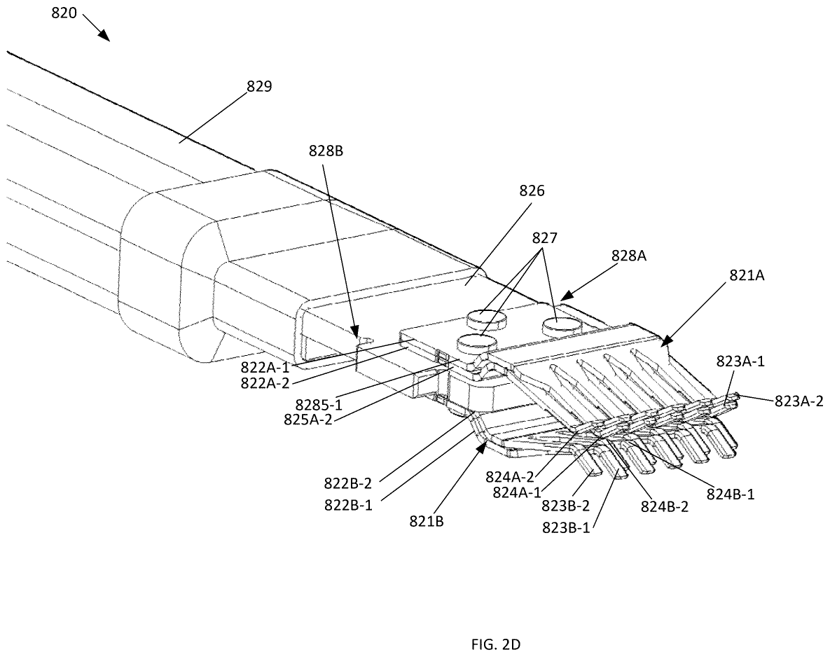

FIG. 2A is a front view of the example receptacle connector of the electrical connection system of FIG. 1.

Receptacle connector 710 includes housing 810. Housing 810 surrounds and supports internal components of the receptacle connector 710 within an internal cavity. Housing 810 includes protrusion 811 for interfacing with the plug of the electrical connection system. Housing 810 includes four openings 812, which expose the terminal assemblies 820 of the receptacle. The terminal assemblies 820 may include power terminals. The protrusion 811 is configured to guide the insertion of the plug connector of the connection system such that the terminals of the plug connector are aligned with the openings 812 and contact the terminals of the receptacle connector.

Housing 810 additionally includes cavity 813 which receives signal conductors 830. The housing may include openings within the cavity 813, which allows signal conductors 830 to pass through the housing and be exposed at the front side of the housing. In this example, the signal conductors are shaped as pins.

FIG. 2B is a front view of the receptacle connector of FIG. 2A. Shown in FIG. 2B is cavity 813 with signal conductors 830. As shown, cavity 813 has a dog bone shape, which may facilitate integration of a desired number of signal conductors in a limited space between power conductors. However other shapes may be used. For example, the cavity 813 may be circular, square, rectangular, elliptical, or any other suitable shape. As shown receptacle connector 710 includes eight signal conductors 830, however other numbers of signal conductors may be used. For example, one signal conductor, two signal conductors, three signal conductors, four signal conductors, five signal conductors, six signal conductors, seven signal conductors, nine signal conductors, one to ten signal conductors, or greater than ten signal conductors may be used.

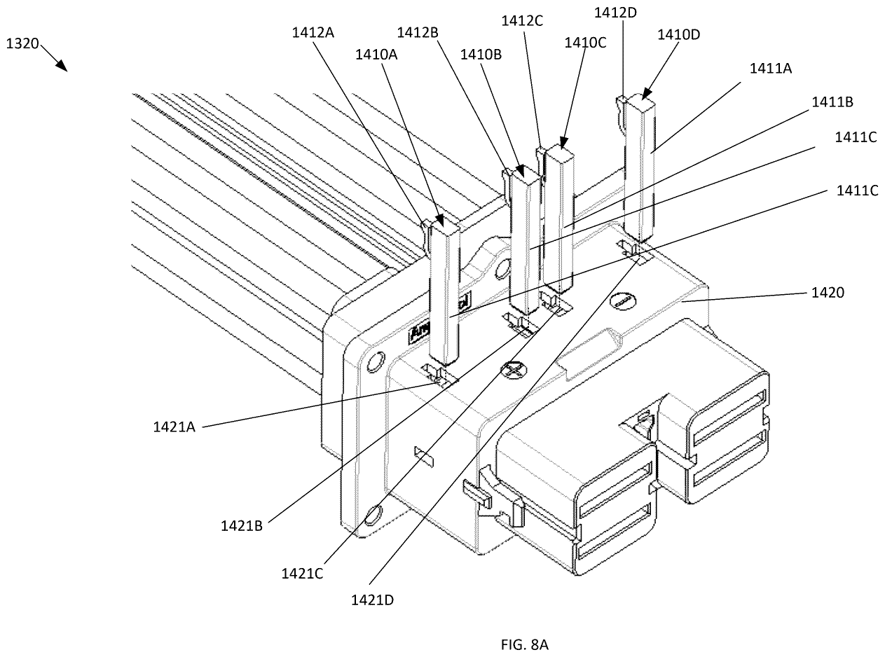

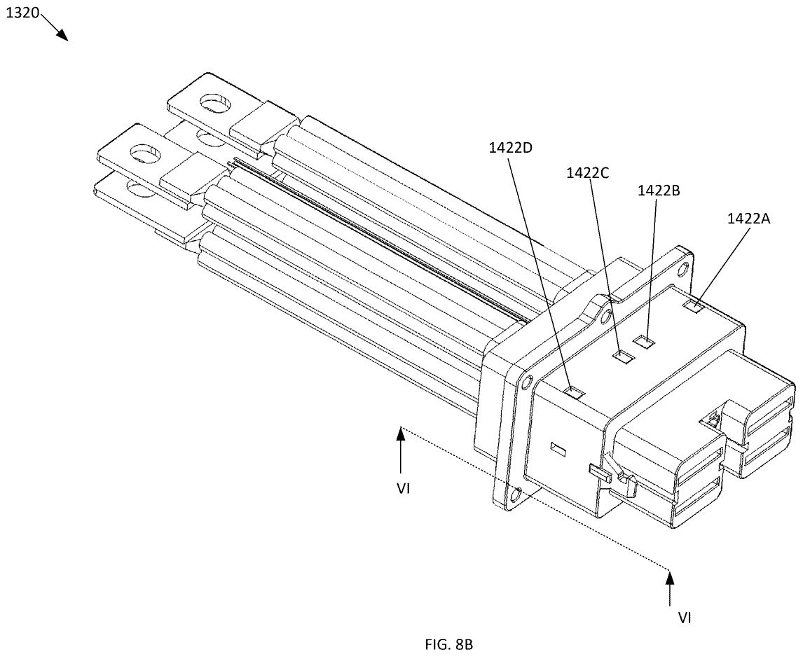

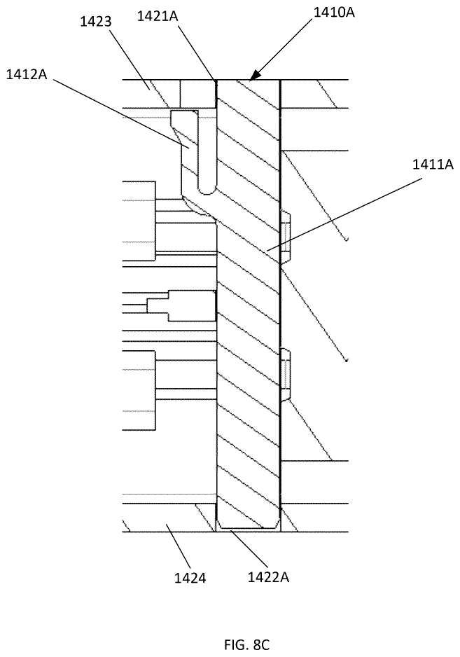

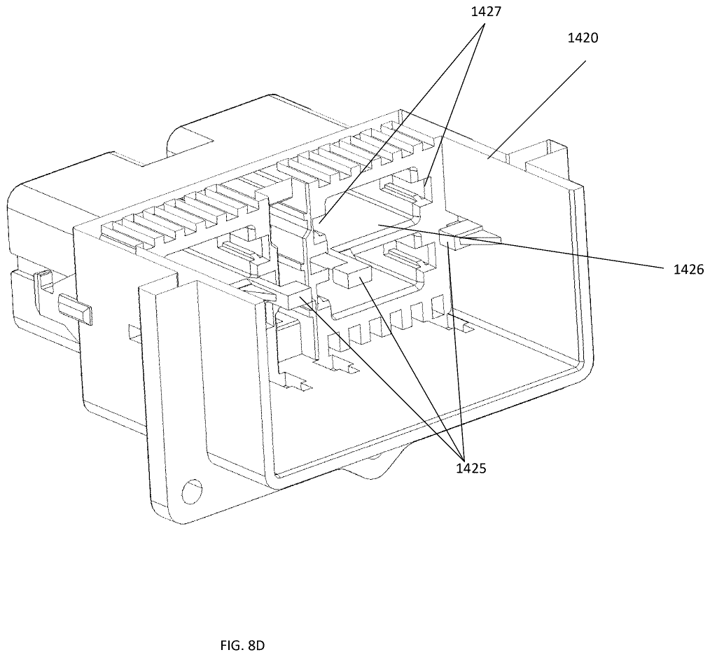

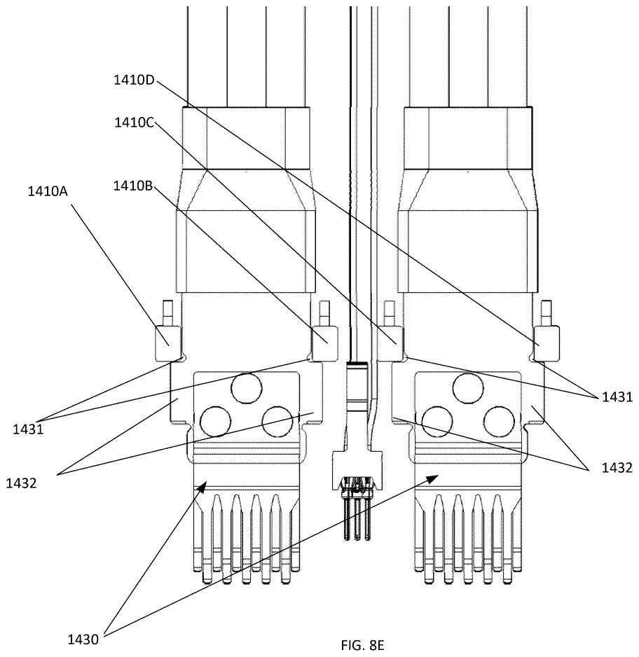

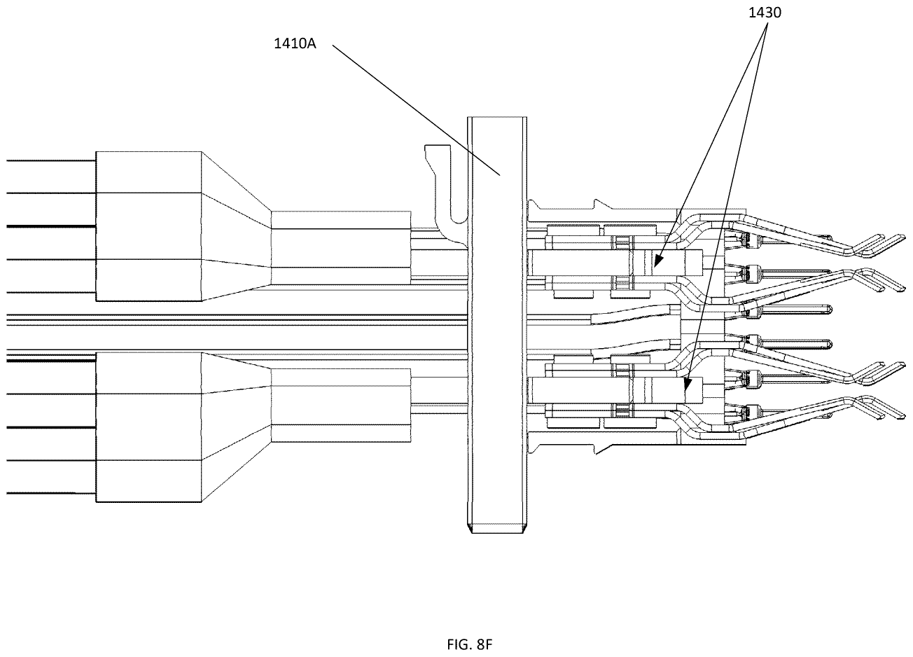

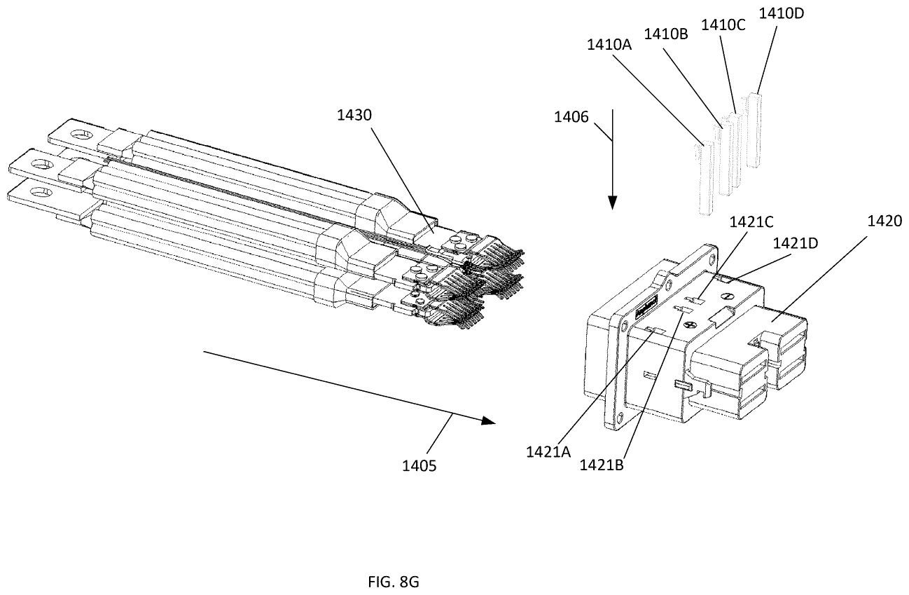

FIG. 2C is a view of internal components of the receptacle connector of FIG. 2A. Receptacle connector 710 includes terminal assemblies Terminals assemblies 820A-D may engage with terminals of the corresponding plug connector of the electrical connection system. Terminals assemblies 820A-D may be secured within the housing by retaining members 840A-D. The securing of the terminal assemblies within a receptacle housing similar to that of FIG. 2C is discussed with regard to FIGS. 8A-G.

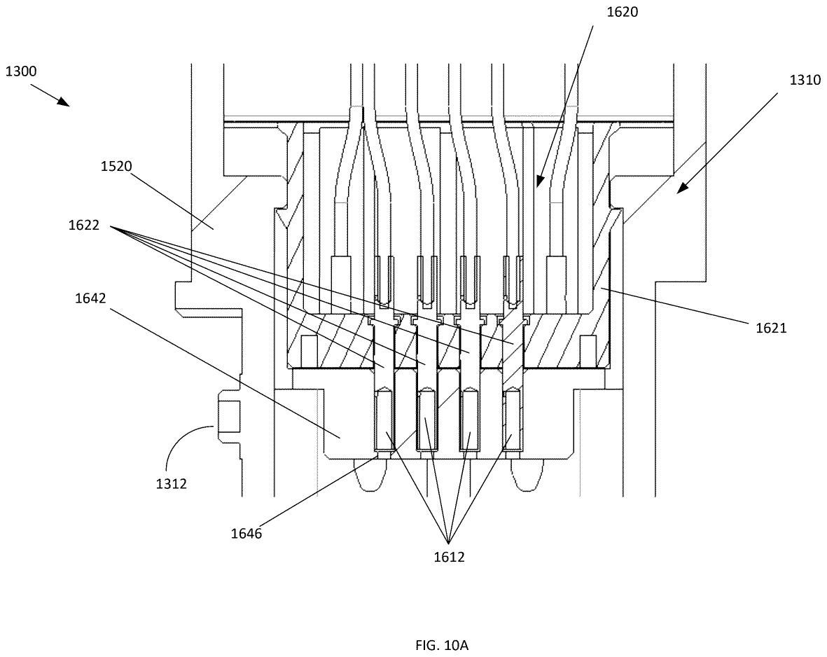

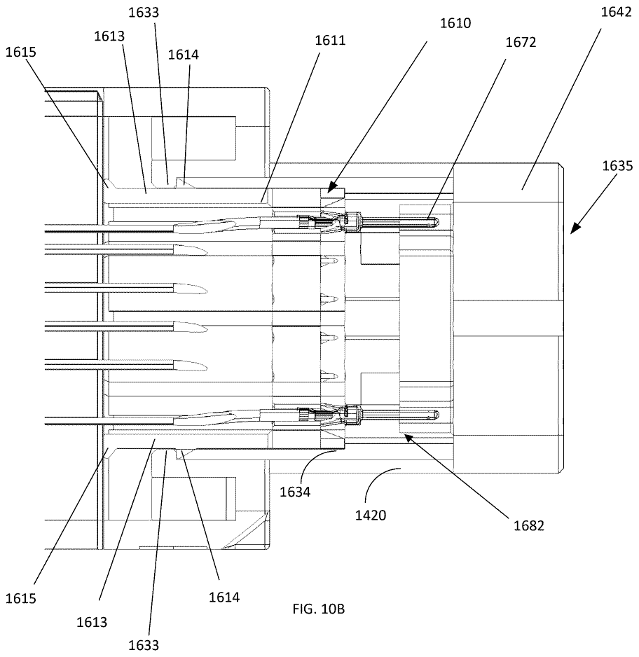

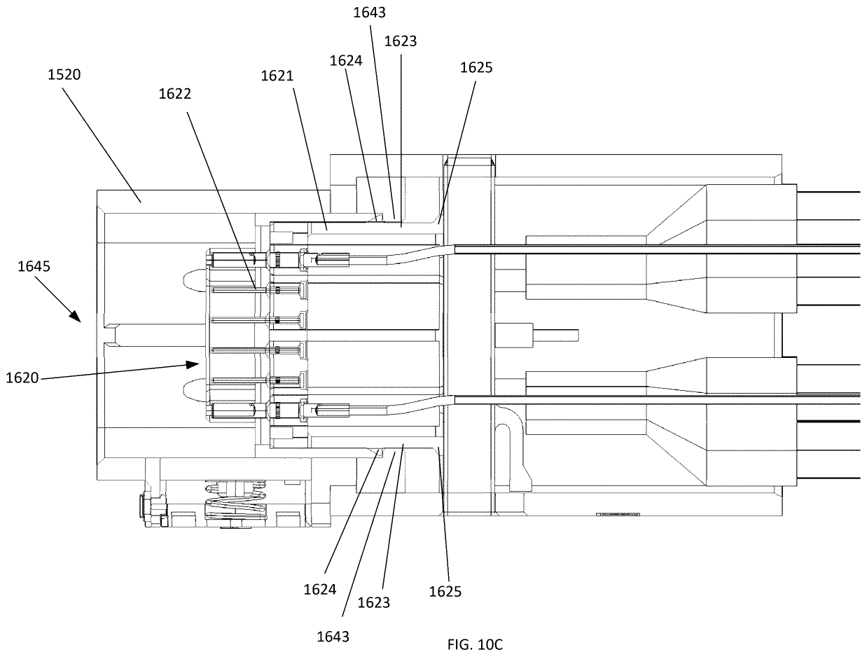

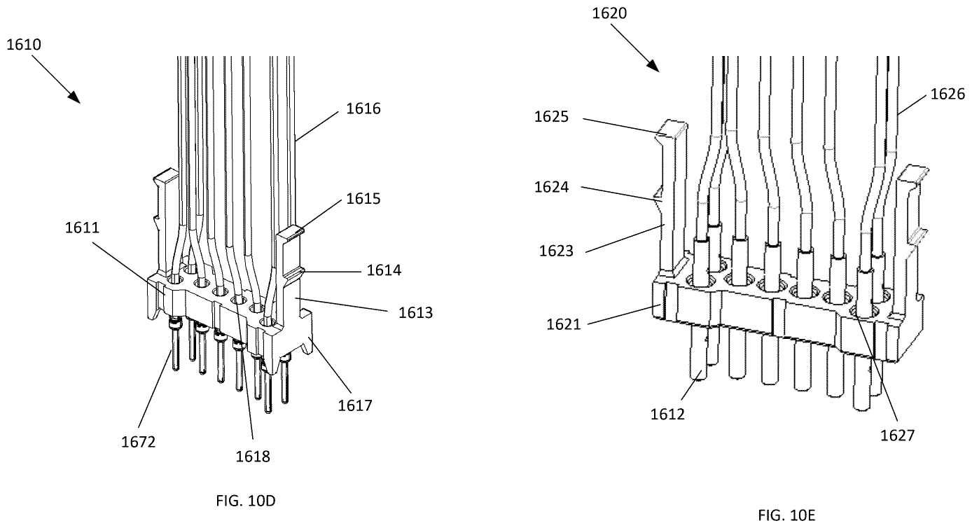

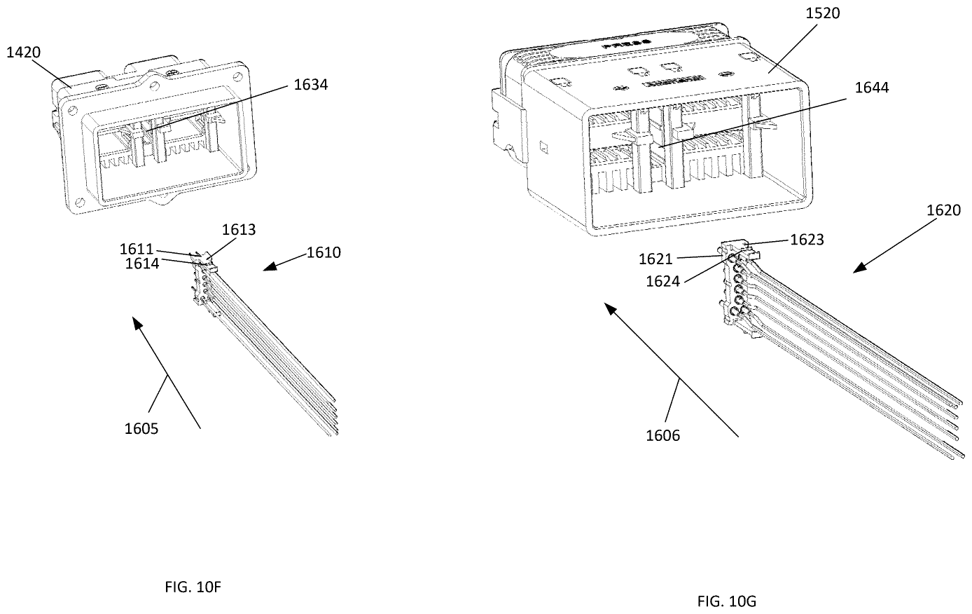

Also shown in FIG. 2C are signal conductors 830 and signal conductor carrier 831. Carrier 831 may engage with the housing, as described with regard to FIGS. 10A-G.

FIG. 2D is a view of a terminal assembly of the receptacle connector of FIG. 2A. In some examples terminal assemblies 820A, 820B, 820C and 820D may have the same construction. Terminal assembly 820 is an example terminal assembly that may represent any of terminal assemblies 820A-D. Terminal assembly 820 includes two conductor assemblies 821A and 821B. Conductor assemblies 821A and 821B may include the same components. As shown, conductor assemblies 821A and 821B are secured to opposite sides of conductor 826 with rivets 827.

Conductor assembly 821A includes a first conductive sheet 822A-1 and a second conductive sheet 822A-2. The conductive sheets may be stamped. First conductive sheet 822A-1 and a second conductive sheet 822A-2 may be formed of a material that is both conductive and compliant, which may be a different material than conductor 826. Conductor 826 may be made of a lower resistance copper alloy than first conductive sheet 822A-1 and second conductive sheet 822A-2, for example.

Conductive sheets 822A-1 and 822A-2 include fingers 823A-1 and 823A-2, respectively. Fingers 823A-1 and 823-2 include contact portions 824A-1 and 824A-2, respectively. The contact portions contact the terminal of the plug connector of the connector when the plug connector is inserted into the receptacle connector 710. The conductive sheets are substantially planar with curved fingers. In some examples, the fingers may be planar. The contact portions are substantially coplanar, in order to contact a planar terminal of a corresponding plug connector. The fingers may be compliant to retain contact with the terminal of the plug connector of the connector when the plug connector is inserted into the receptacle connector 710.The fingers 823A of conductor assembly 821A and the fingers 823B of conductor assembly 821B may be spread apart when the terminal of the plug connector is inserted into the receptacle connector and contacts the fingers. Rivets 827 secure the conductor assemblies 821A and 821B to the conductor 826 at mounting portion 825A-1, 825A-2, 825B-1 and 825B-2 of the first and second conductive sheets of the first and second conductor assemblies, respectively. Conductor 826 may be electrically and mechanically connected to a conductor within cable 829. Conductor 826, for examples, may be welded to the conductors or may be formed by fusing and/or shaping one or more strands of the conductor within the cable.

Conductor 826 additionally includes positioning notches 828A and 828B which may engage with a retaining member, such as retaining members 840A-D, to secure the terminal within the housing of the receptacle connector. Securing of the terminal assemblies within a receptacle housing similar to that of FIG. 2C is discussed with regard to FIGS. 8A-G. That retention mechanism may similarly be applied to a connector as in FIG. 2C. Terminal assembly 820 additionally includes cable 829 which is terminated to conductor 826, such as by crimping or welding. Cable 829 may connect to one or more electronic components or devices.

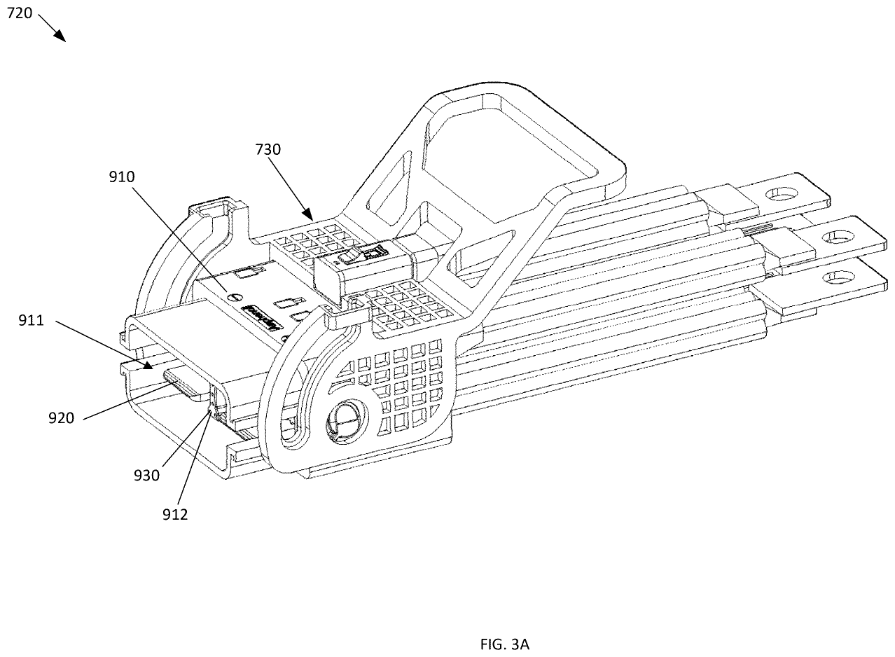

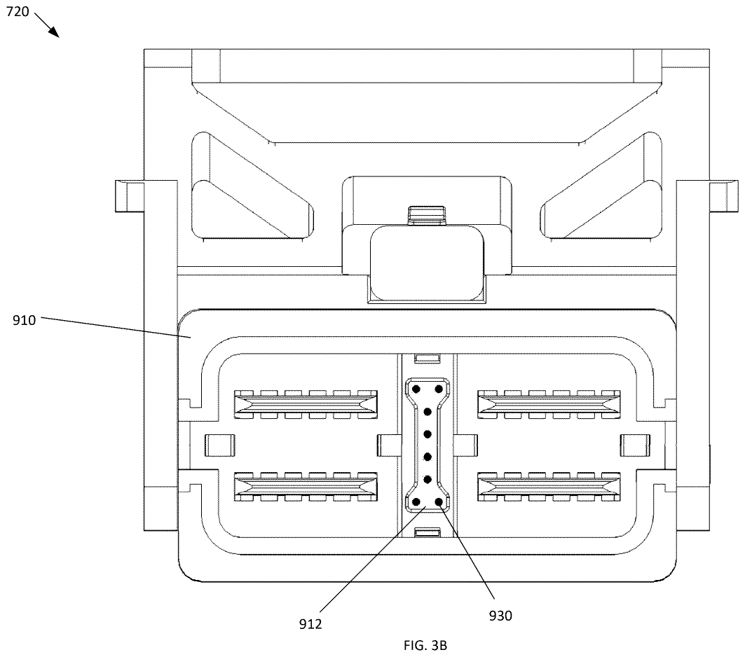

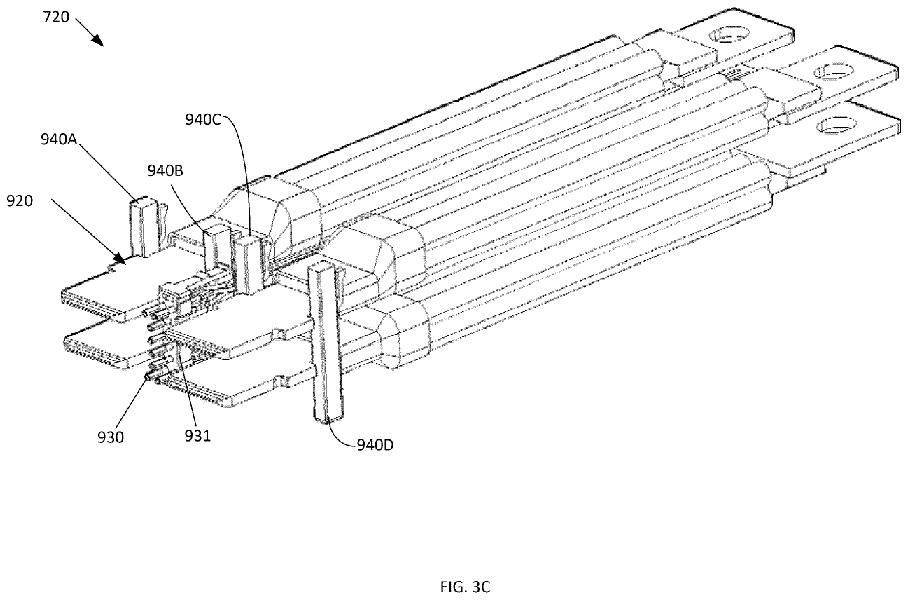

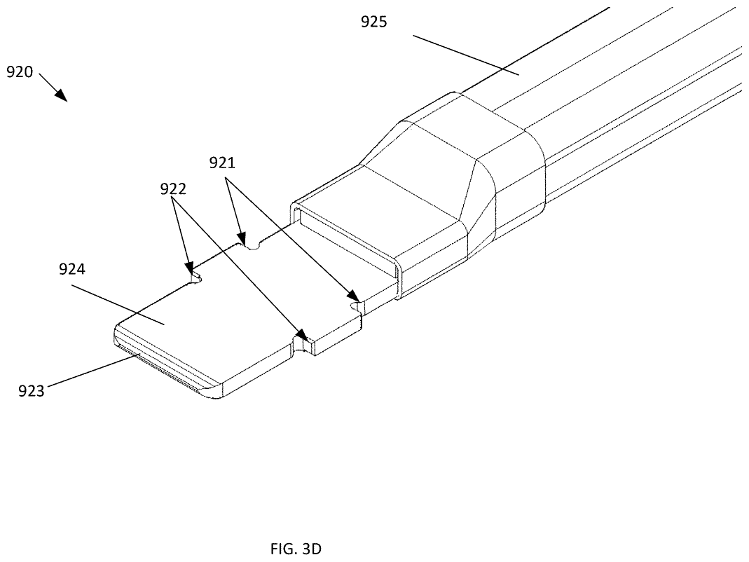

FIG. 3A is a front view of the example plug connector 720 of the electrical connection system of FIG. 1.

Housing 910 includes mating interface 911, which engages with the housing of the receptacle connector. The mating interface includes the mating contacts of the terminal assemblies 920, which are exposed through openings in the housing 910. In this example, the mating contacts are configured as blades and mate with the mating contacts of the terminals of the receptacle connector, which are in the example of FIGS. 2A-D are shaped a spring fingers.

Also visible in FIG. 3A is signal conductor protrusion 912, which in this example is integrally formed as a portion of housing 910. The signal conductor protrusion may be shaped to fit within with the cavity in which the signal conductors of the corresponding receptacle connector of the connection system are positioned. In this example, the signal conductors 930 are exposed through openings in protrusion 912. The signal conductors may have mating contact portions configured to mate with the signal conductors of the mating connector. In this example, they may be shaped as receptacles and may, for example, have a tubular shape.

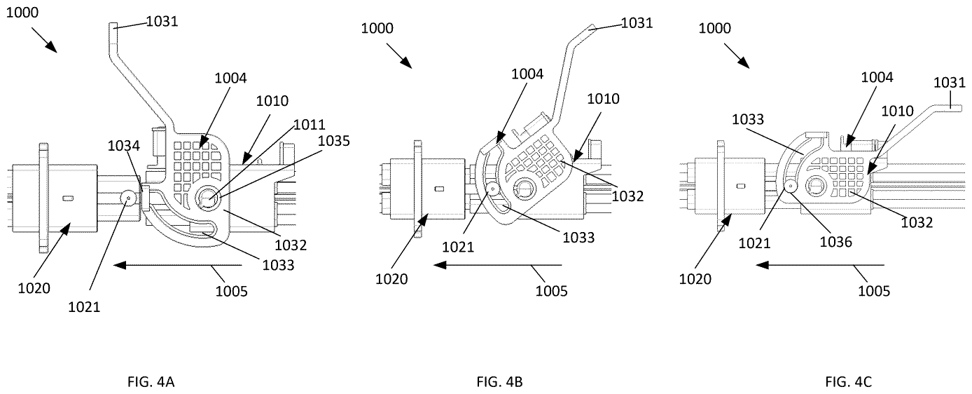

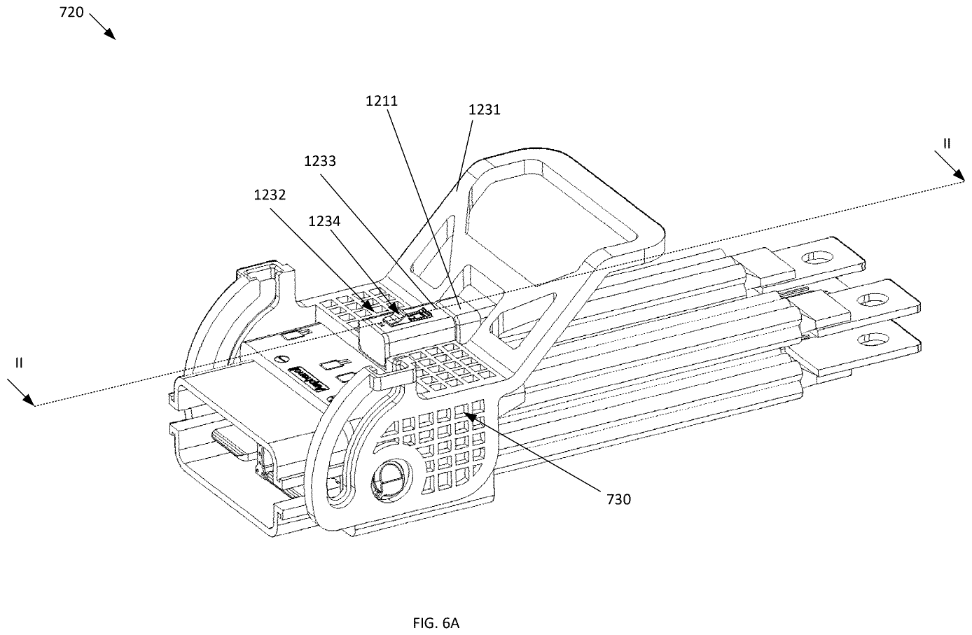

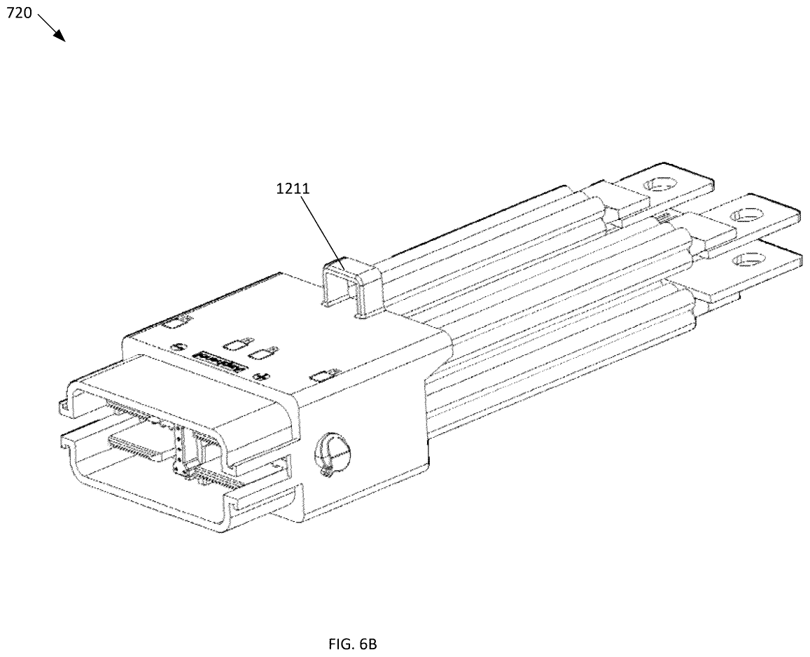

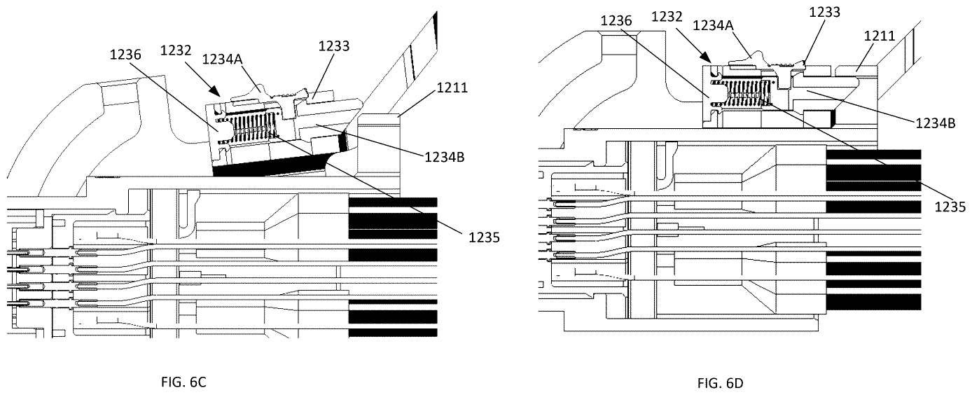

Also shown is latch mechanism 730. Latch mechanism 730 is a rotating latch. Examples of other latch mechanisms that may be used in in a high current connector as described herein are shown in FIG. 4 and FIGS. 6A-D.

FIG. 3B is a front view of the plug of FIG. 3A. The signal conductor protrusion 912 is shown in FIG. 3B. The signal conductor protrusion has a shape corresponding to the shape of the cavity of the receptacle connector of FIG. 2B, which in this example is a dog bone shape. As shown the plug 720 includes eight signal conductors 930.

FIG. 3C is a view of internal components of the example plug of FIG. 3A. Plug 720 includes terminal assemblies 920A, 920B, 920C and 920D. Terminal assemblies 920A-D may mate to corresponding terminal assemblies of the receptacle of the electrical connection system. Terminal assemblies 920A-D may be secured within the housing by retaining members 940A-D.

Also shown in FIG. 3C are signal conductors 930 and signal conductor carrier 931. Carrier 931 may engage with the housing to retain the signal conductors within the housing. In this example, signal conductor protrusion 912 includes a cavity and the signal conductor carrier 931 fits within the cavity with the mating contact portions of the signal conductors 930 aligned with openings in the signal conductor protrusion 912.

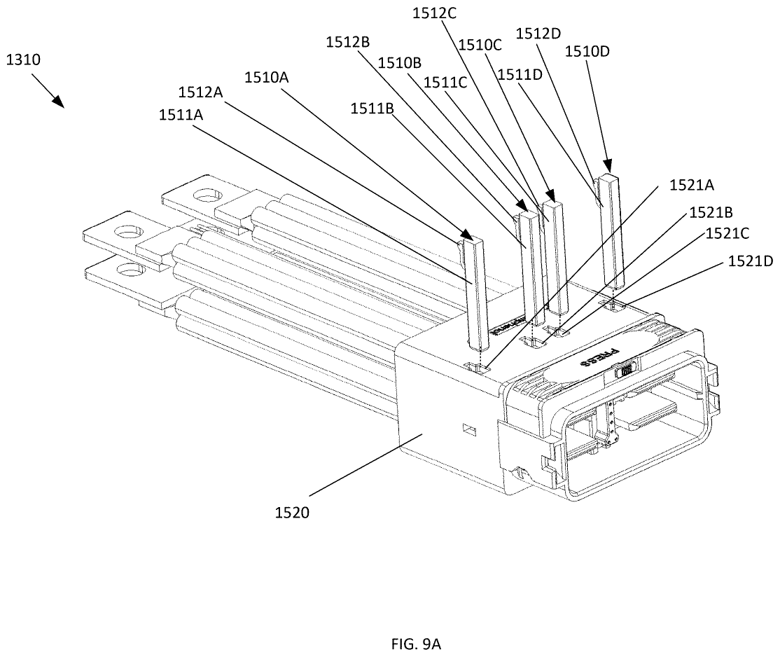

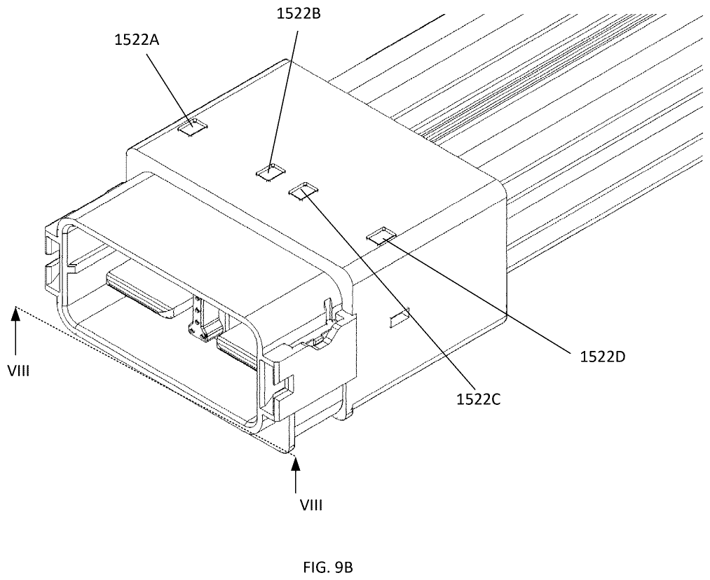

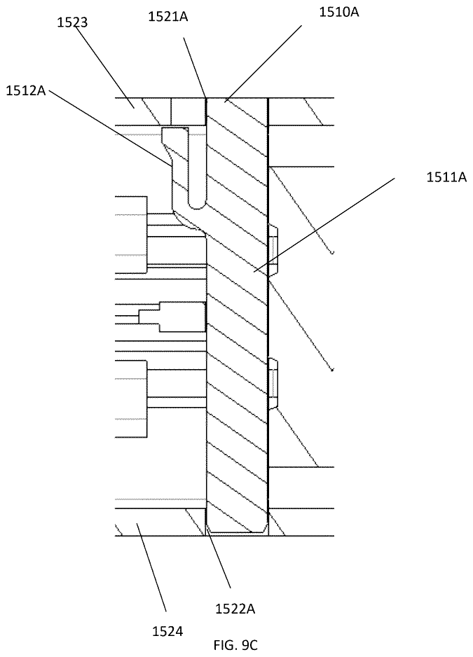

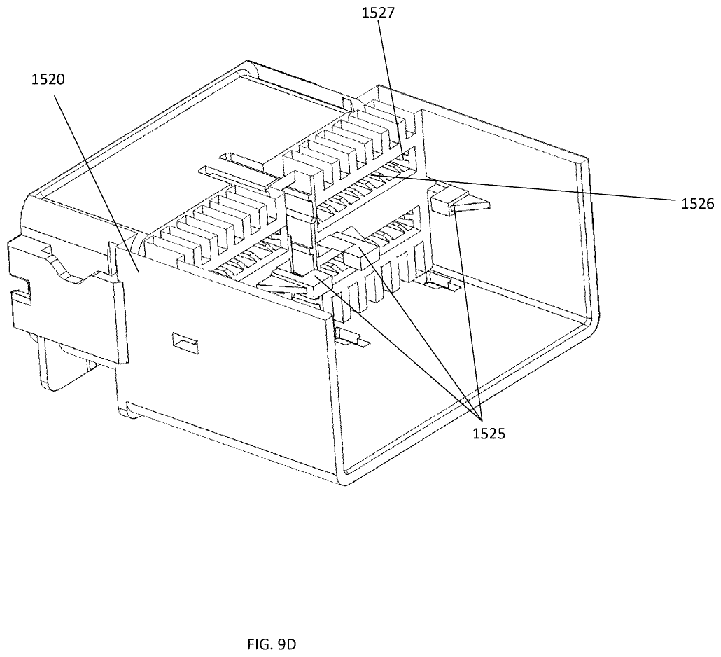

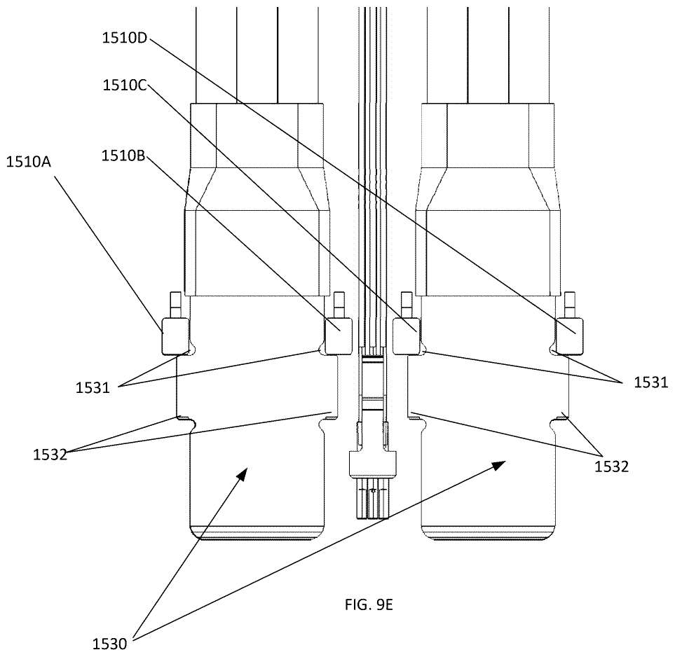

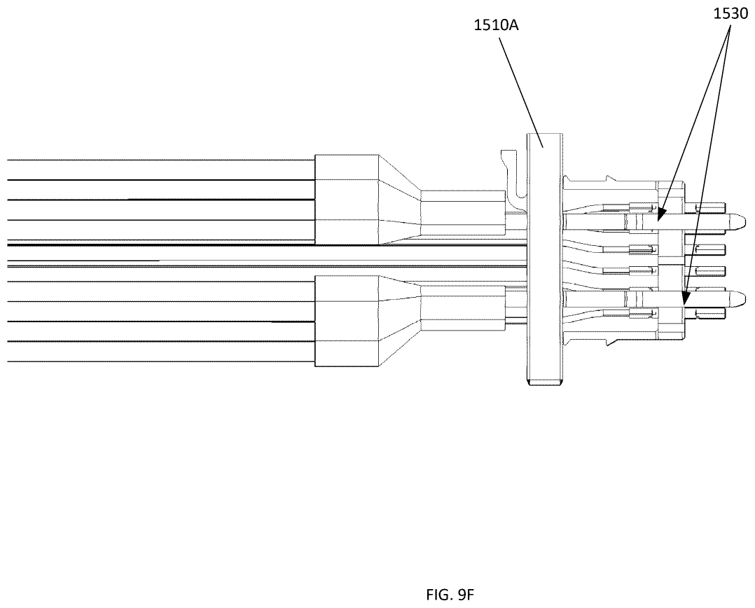

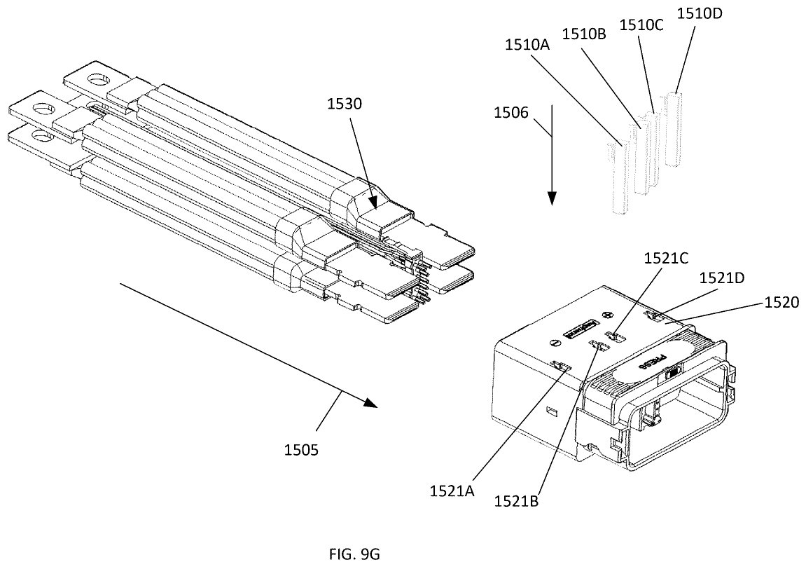

FIG. 3D is a view of a terminal assembly of the example plug of FIG. 3A. Terminal assembly 920 is an example terminal assembly which may be representative of any of the terminal assemblies 920A-D. In this example, the terminal assemblies 920A-D have the same shape terminal assembly 920. Terminal assembly 920 includes conductive terminal 924 with positioning notches 921, which may engage with retaining members to retain the terminal assembly within the housing. Exemplary retention members are shown as retaining members 1510A-D (FIG. 9A) and such retaining members may be use in connection with a connector as illustrated in FIG. 3D.

Terminal 924 additionally includes edges 922 which may interface with one or more features of the housing to position the terminal assembly 920 within the housing. For example, the edges may contact one or more surfaces or channels such as alignment channels 1527, as described with reference to FIG. 9D, to position the terminal assemble within the housing.

Tip portion 923 of the terminal 924 has a tapered shape which may aid in spreading of the fingers of the terminals of the receptacle, during a mating process. Terminal 924 is substantially planar, for example the terminal may be configured as a flat terminal or a blade. Terminal assembly 920 additionally includes cable 925 which is terminated to terminal 924, such as by crimping or welding. Cable 925 may connect to one or more electronic components or devices.

FIGS. 4A-C is an example connection process of a high current electrical connection system with a rotating latch, according to some examples of the technology described herein. The electrical connection system 1000 includes receptacle 1020 and plug 1010. These connectors may have signal and power terminals according to any of the embodiments described herein. The connection process begins in a position as illustrated in FIG. 4A.

In the example illustrated, latch 1030 includes a race configured to receive a protrusion from the mating connector. In FIG. 4A, latch 1030 is positioned such that the protrusion is aligned with an opening of the race such that the protrusion can enter the race when the connectors are pressed together in the mating direction. In the example of FIG. 4A, the latch 1030 is in an open position with the handle 1031 positioned approximately at a right angle relative to the top surface of the housing of the plug connector. The opening 1034 of the race 1033 of the side 1032 of the latch 1030 is facing the front side of the plug connector 1010 when the latch is in the open position. The latch may include a second channel, opening and side, on the opposite side of the connection system not visible in the view of FIG. 4A.

The circular protrusions 1021 of the housing of the receptacle may fit within the opening 1034 of the race 1033 when the plug 1010 is moved in the insertion direction 1005 towards the receptacle. The circular protrusions 1021 of the housing of the receptacle may include a first portion attached to the housing and a second portion, wider than the first portion, attached to the first portion. The first portion may extend through the side 1032 and the second portion may be wide enough to prevent side 1032 from spreading and allowing the first portion to slip out of race 1033. Opening 1034 may be large enough to allow the second portion to pass through the opening. In this example, side 1032 includes a recessed portion bounding race 1033 and the second portion of the protrusion 1021 may fit, in whole or in part, within the recessed portion.

The latch 1030 may be rotated about a hub or other rotational coupling member protrusion 1011. Rotational coupling member protrusion 1011 in this example is a portion of the housing of the plug 1010 of the electrical connection system. The plug may include a second rotational coupling member on the side opposite that shown in FIG. 4A, that is not visible in FIG. 4A. The latch includes hole 1035 which may receive the rotational coupling member protrusion 1011 and allow the latch to rotate about the rotational coupling member protrusion 1011.

When the circular protrusion 1021 of the receptacle 1020 has entered the race 1033 through the opening 1034, the latch 1030 may be rotated towards the top surface of the housing of the plug 1010. FIG. 4B shows the latch 1030 mid-rotation, with the circular protrusion 1021 in the middle of the race 1033. The latch 1030 may be rotated by a user of the connection system 1000, by pulling or pushing on the handle 1031.

The latch 1030 may be further rotated into a secured position. Optionally, one or more structures may be used to releasably hold latch 1030 in the secured position. FIG. 4C shows the latch 1030 in the secured position. When in the secured position, the terminals of the plug 1010 and receptacle 1020 are electrically connected.

As the latch 1030 is rotated towards the top surface of the housing of the plug connector 1010, the plug 1010 and receptacle 1020 may be pulled together along the insertion direction 1005. As latch 1030 rotates from the position shown in FIG. 4A to that shown in FIG. 4C, the protrusion 1021 traverses race 1033 from the opening 1034 to its final position as shown in FIG. 4C. Race 1033 is curved with a shape such that, as the protrusion traverses the race, the distance between protrusion 1021 and rotational coupling member protrusion 1011 decreases. In the illustrated example, the circular protrusion 1021 is at the end 1036 of the race 1033 in the secured position shown in FIG. 4C with the smallest separation.

In some examples, the latch mechanism 1004 of the electrical connection system may include one or more locking features which may engage when the latch 1030 is in the secured position. In some examples, the locking features may automatically engage when the latch 1030 is rotated to the secured position. In some examples, the locking features may be manually engaged by a user of the electrical connection system 1000.

The latch mechanism 1004 may be disengaged, allowing the plug 1010 to be unmated from the receptacle 1020. In some examples, the latch mechanism may be disengaged by moving the latch 1030 away from the secured position towards the open position. Once the latch is in the open position, the plug 1010 may be moved in a direction, opposite the insertion direction 1005, and be removed from the receptacle 1020. In some examples, a locking feature of the latch mechanism 1004 may be disengaged before rotating the latch to disengage the latch mechanism.

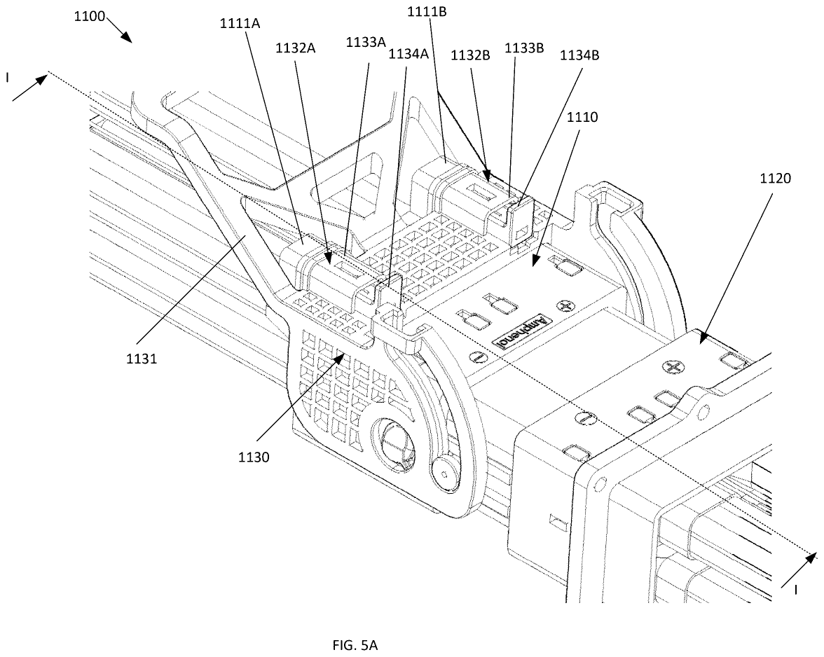

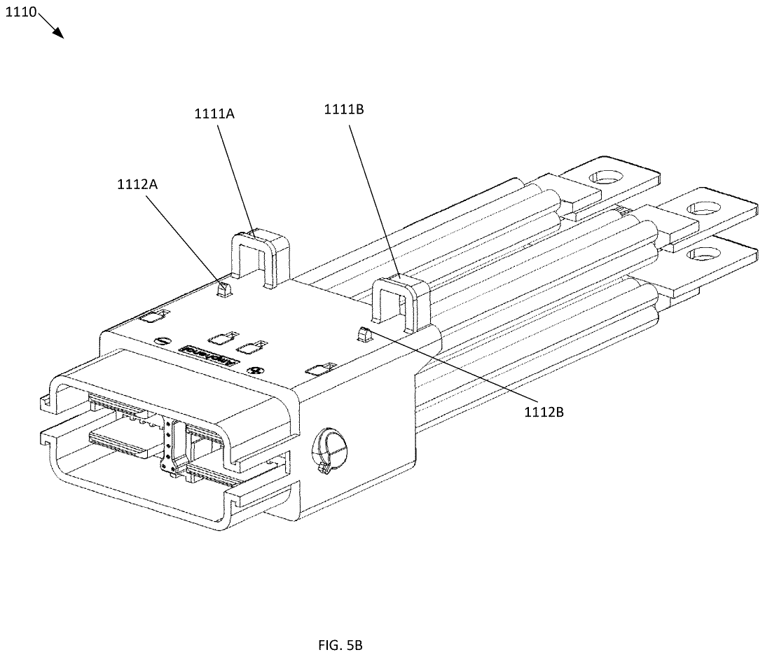

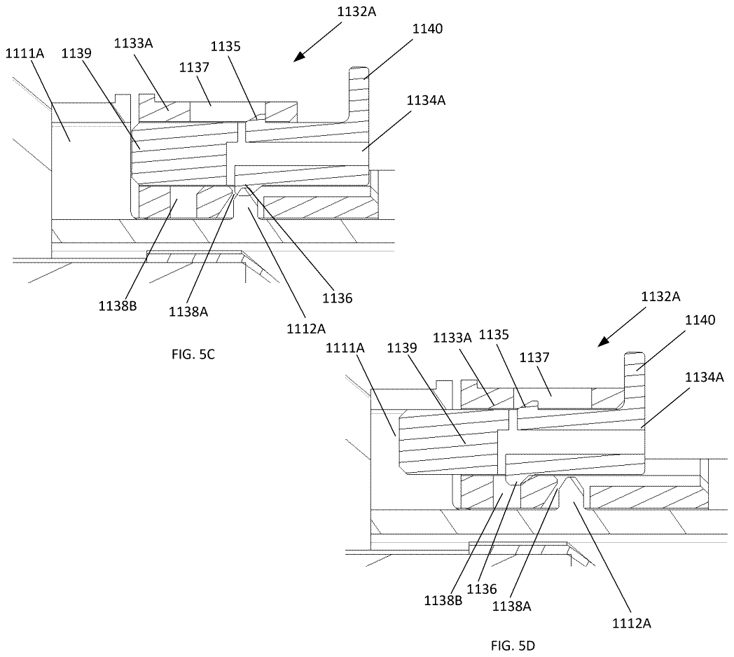

FIG. 5A illustrates a high current electrical connection system with a two point locking latch, according to some embodiments of the technology described herein. This locking system may be used with a connector with a rotating latch. The electrical connection system 1100 includes multiple terminals and may have the same or similar internal components to those discussed with relation to electrical connection system 700 of FIGS. 1-3D. The latch 1131 may be operated as discussed with reference to FIGS. 4A-C to secure the plug 1110 and receptacle 1120 of the electrical connection system.

The latch mechanism 1130 includes two locking features 1132A and 1132B. The locking features may be automatically or manually engaged when the latch is moved to the secured position, in order to retain the latch in the secured position and maintain the connection of the plug and receptacle connectors. While the latch mechanism of FIG. 5A includes two locking features, the latch mechanism may include greater or fewer locking features.

In this example, locking features 1132A and 1132B may include complementary features on the latch and the plug housing. In this example, the locking features on latch 1130 are locking channels 1133A and 1133B respectively and locking sliders 1134A and 1134B respectively. The locking sliders 1134A and 1134B may automatically move within locking channels 1133A and 1133B. The locking features on the connector housing are apertures 1111A and 1111B on an exterior surface of the housing of the plug. The locking sliders may align with the apertures when the latch is moved to the secured position such that the locking sliders may slide into the apertures to engage the locking features. When the locking features 1132A and 1132B are engaged, the latch cannot rotate therefore the plug and receptacle of the electrical connection system cannot be separated and the electrical connection is maintained.

FIG. 5B is a view of the plug 1110, with the latch removed, of the high current electrical connection system of FIG. 5A. The top surface of the housing of the plug is shown in FIG. 5B. The top surface includes apertures 1111A and 1111B, which receive locking sliders of locking features, when the latch mechanism is moved to the secured position. The top surface additionally includes locking protrusions 1112A and 1112B. Locking protrusions may pass through corresponding openings in the latch of the latch mechanism and interact with locking sliders. The locking protrusions 1112A and 1112B may enable the corresponding locking sliders to move into the apertures 1111A and 1111B when the latch is moved to the secured position.

FIG. 5C is a section view of the locking feature 1132A of the high current electrical connection system of FIG. 5A in a disengaged position. In this example, end 1139 is outside of apertures 1111A such that the locking feature is not engaged. The view of FIG. 5C is taken along line I-I in FIG. 5A. The features and operation of locking feature 1132A are shown in FIG. 5C, and the locking feature 1132B may include the same or similar features and may function as discussed with regard to locking feature 1132A.

The locking slider 1134A includes two compliant arms 1135 and 1136. First arm 1135 interacts with slot 1137 in the locking channel 1133A to retain the locking slider within the locking channel 1133. In this example, arm 1135 has a hooked distal end that prevents locking slider 1134A from falling out of locking channel 1133A accidentally.

Second compliant arm 1136 has a first state in which it interferes with locking slider 1134A being pushed into aperture 1111A and a second state, offset from the interfering first state, in which locking slider 1134A may be pushed into aperture 1111A. Second compliant arm 1136 may be biased into the first state and pushed from the first state to the second state by interacting with the locking protrusion 1112A through opening 1138A n the locking channel 1133A. This interaction occurs when latch 1130 is rotated into the secured position with the latch 1130 pressed against the surface of the plug housing.

FIG. 5C is a schematic illustration of the latch not in the secured position. In this position, the locking slider is disengaged and a distal end of second compliant arm 1136 extends into opening 1138A if latch 1130 is not rotated into the secured position. As can be seen in FIG. 5C, when a distal end of second compliant arm 1136 extends into opening 1138A, the distal end will abut the wall of the floor of locking channel 1133 between openings 1138A and 1138B. As a result, slider cannot be pushed into aperture 1111A. Such a configuration blocks a user from engaging locking feature 1132A if the latch 1130 is not rotated into the secured position. Such a feature reduces operator errors, as the user receives feedback from being unable to push the locking slider into the locked position.

FIG. 5C also schematically illustrates interference between locking protrusion 1112A and the distal end of second compliant arm 1136 when latch 1130 is rotated into the secured position. In this secured position, which in this case results in latch 1130 being against the surface of plug housing including locking protrusion 1112A, locking protrusion 1112A, passes through the opening 1138A and presses against the distal end of second compliant arm 1136. That pressing may lift the distal end of second compliant arm 1136 so that it does not abut the portion of the floor between openings 1138A and 1138B, enabling the locking slider to be pushed into aperture 111A, locking the connectors in the secured position, as shown in FIG. 5D.

Further, once the locking slider is pushed into the locked position, the distal end of second compliant arm 1136 may align with opening 1138B. Because that arm is compliant the distal end of second compliant arm 1136 may extend into opening 1138B when the locking slider is engaged. In the example of FIG. 5D, the distal end of second compliant arm 1136 is shaped such that it will hook on the forward side of the portion of the floor of locking channel 1133 between openings 1138A and 1138B. As a result, substantially more force will be required to retract the slider than to engage the slider when the latch is in the secured position. Such operation further reduces the possibility of operator error.

The locking feature 1132A alternatively or additionally may provide a visual indication that the latch 1131 is properly closed, and thus the connection between the plug connector 1110 and receptacle connector 1120 are properly secured. The visual indication is provided by the edge 1140 of the locking slider 1134A. In the disengaged position, there is a gap between the edge 1140 of the locking slider 1134A and the locking channel 1133A, while in the engaged position, there is no gap between the edge 1140 of the locking slider and the locking channel 1133A. In some examples, an upper surface of locking slider 1134A that is outside the locking channel 1133A in the state illustrated in FIG. 5C but inside the locking channel in the state illustrated in FIG. 5D may be colored or contain other visible indicator such that, if a user sees that visible indicator the user may understand that the locking mechanism is not properly engaged. Alternatively or additionally, an audible indication of proper engagement of locking feature 1132A may be provided. In some examples, second compliant arm 1136 may be sufficiently stiff such that, when the distal end of second compliant arm 1136 drops into opening 1138B to enter the state shown in FIG. 5D, second compliant arm 1136 may strike the portion of the floor of locking channel 1133 between openings 1138A and 1138B, making a sound indicating proper locking.

The locking feature 1132A may be disengaged before rotating the latch 1131 from the secured position to the open position. In some examples, the locking feature may be disengaged by pushing the edge 1140 of the locking slider away from the aperture 1111A, such that the second protrusion moves from opening 1138B to opening 1138A.

As a result of the interaction between locking protrusion 1112A and second compliant arm 1136, an easy to use latch position assurance function may be implemented by locking feature 1132A. As described above, if the latch 1131 is properly closed that interaction enables the locking slider to slide. Conversely if latch 1131 is not properly rotated into its closed state, movement of locking slider may be blocked such that a user may quickly realize that latch 1131 is not properly closed. Once the latch 1131 is properly closed, as a result of interaction between locking protrusion 1112A and second compliant arm 1136 automatically releases second compliant arm 1136 from its restrained position without separate action of the user.

In some examples, multiple locking features may not be required. In some examples, a single locking feature may be used. In other examples, more than two locking features may be used. Further, in some examples, it may be desirable to have a locking feature that automatically engages when the latch is moved to the secured position. Such variations are illustrated in connection with FIGS. 6A-D, though the techniques illustrated may be applied to other connectors described herein.

FIG. 6A is a view of the plug connector of a high current electrical connection system with a spring locking latch. The electrical connection system of FIGS. 6A-D is that of FIGS. 1-3D. The latch mechanism 730 may be operated as discussed with reference to FIGS. 4A-C to connect the plug 720 and receptacle 1220 of the electrical connection system.

In this example, latch mechanism 730 includes one locking feature 1232. The locking feature 1232 includes locking channel 1233 and locking slider 1234. In this example, locking slider 1234 may spring biased such that it automatically moves within locking channels 1233 into aperture 1211 of the housing of the plug when the latch is moved to the secured position.

FIG. 6B is a view of the plug of the high current electrical connection system of FIG. 6A with the latch mechanism removed. The top surface of the housing of the plug is shown in FIG. 6B. The top surface includes apertures 1211, which receive the locking sliders of the locking features. In this example, as with the example of FIG. 5B, the apertures are formed with hooped shaped projections extending from the upper surface of the plug housing. When the locking slider 1234 is moved into the aperture 1211, the latch is secured and cannot rotate, holding plug 720 and the corresponding receptacle in a mated position.

FIG. 6C is a section view of a locking feature of the high current electrical connection system of FIG. 6A in a disengaged position. The view of FIG. 6C is taken along line II-II in FIG. 6A. The components contained within the locking channel are visible in FIG. 6C. A locking slider 1234 includes external portion 1234A which is exposed on the exterior of the locking channel 1233 and may enable a user to slide the locking slider to disengage the locking feature 1232. In this example, external portion 1234A is formed separately from engaging portion 1234B and includes a protrusion which engages with a cavity in engaging portion 1234B, allowing the external and engaging portions of the locking slider to be moved together within the locking channel 1233.

The locking feature 1232 additionally includes spring 1235 and cap 1236. Cap 1236 closes an end of the locking channel 1233 and includes hooked protrusions which engage with slots within the locking channel to secure the cap 1236 to the end of the locking channel. The spring 1235 is positioned between the cap 1236 and the engaging portion 1234B of the locking slider 1234. The spring urges the locking slider 1234 towards the end of the locking channel 1233, opposite the cap 1236. The spring, however, can be compressed to enable the locking slider 1234 to move within the locking channel 1233 towards the cap. As the latch is moved into the secured position, slider 1234 may be pressed towards cap 1236, compressing the spring.

When the latch is moved from the open to the secured position, the end of the locking slider, exposed through the end of the locking channel 1233, opposite the cap 1236, contacts the top edge of the hoop forming aperture 1211. FIG. 6C illustrates the latch in a position when it is about to touch the hoop forming aperture 1211. The forward surface of the locking slider is tapered such that contact with the hoop causes the locking slider to move within the locking channel 1233, towards the cap 1236, until the latch is in the secured position. When the latch is in the secured position, the locking slider is aligned with the aperture and no longer contacts a portion of the plug housing bounding the aperture. In this state, the spring urges the locking slider forward within the locking channel 1233, such that a portion of the locking slider slides into the aperture 1211.

FIG. 6D is a section view of a locking feature of the high current electrical connection system of FIG. 6A, in an engaged position. The view of FIG. 6D is taken along line II-II in FIG. 6A. In FIG. 6D, the locking slider 1234 is contained within the aperture 1211. This causes the latch 1231 to be secured and to hold the plug and receptacle in a mated state.

The locking feature 1232 may be disengaged by a user by moving the locking slider 1234 by pushing the external portion 1234A away from the aperture. When the locking slider 1234 is no longer contained within the aperture, the latch 1231 may be rotated to the open position, allowing the plug 720 and corresponding receptacle to be separated. In examples in which the plug and receptacle are pulled together as a result of a projection from one connector in a race of a latch mounted to the other connector, rotating the latch from the secured to the open position may urge the connectors apart.

The automatic engagement of the locking feature 1232 may provide an indication to the user that the latch has been successfully secured. That feedback may be audible, For example, when the locking feature 1232 engages it may emit a click or similar sound that a user may hear, confirming a successful locking of the connectors together to ensure that the electrical connections formed through the connector are reliable and stable. A clicking sound my be forced by configuring locking slider 1234 with a surface that hits a corresponding surface of locking channel 1233, or in some examples, other portion of the plug or mating connector, when the locking slider moves into its secured position.

In some examples, a visual indication of secure engagement may be provided by forming at least the distal portion of engaging portion 1234B of visually distinctive material, such as brightly colored plastic. When that portion is securely within aperture 1211, it may not be visible, but may be visible if not secured within aperture 1211.

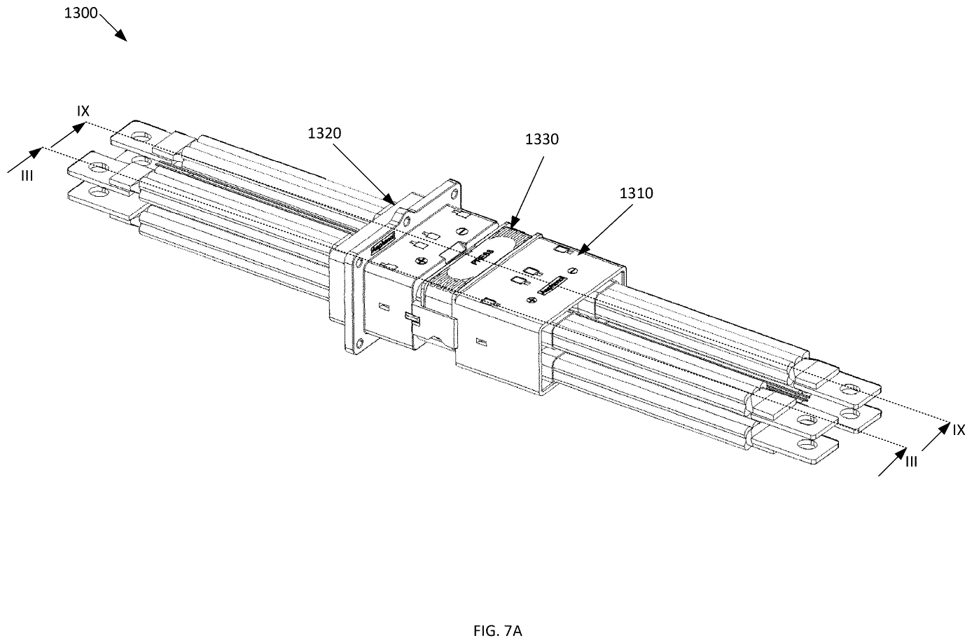

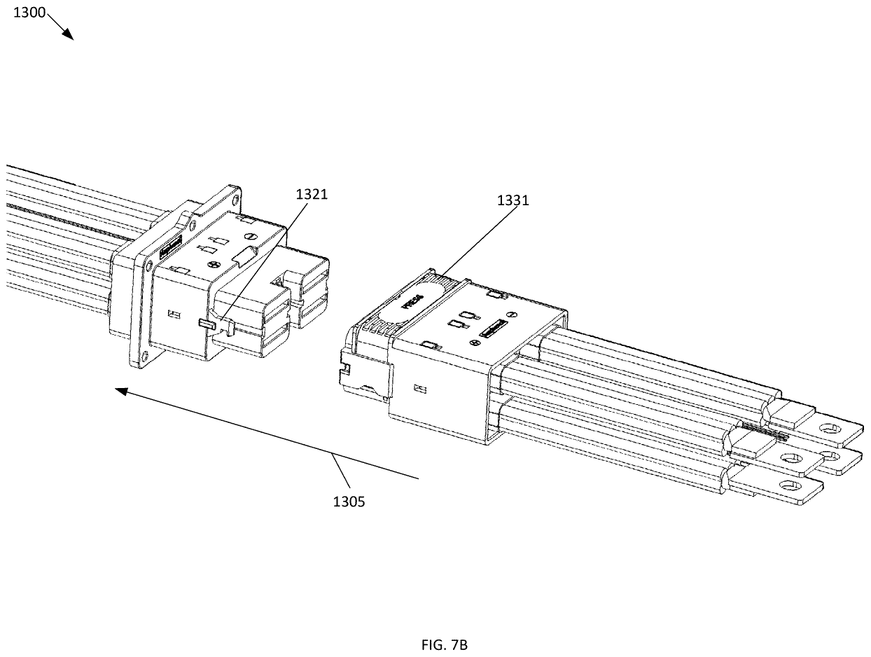

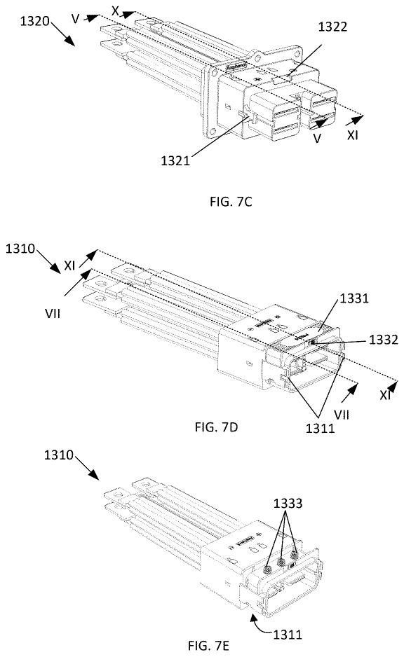

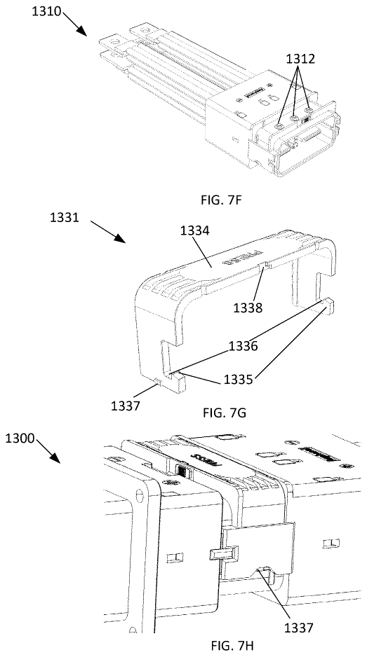

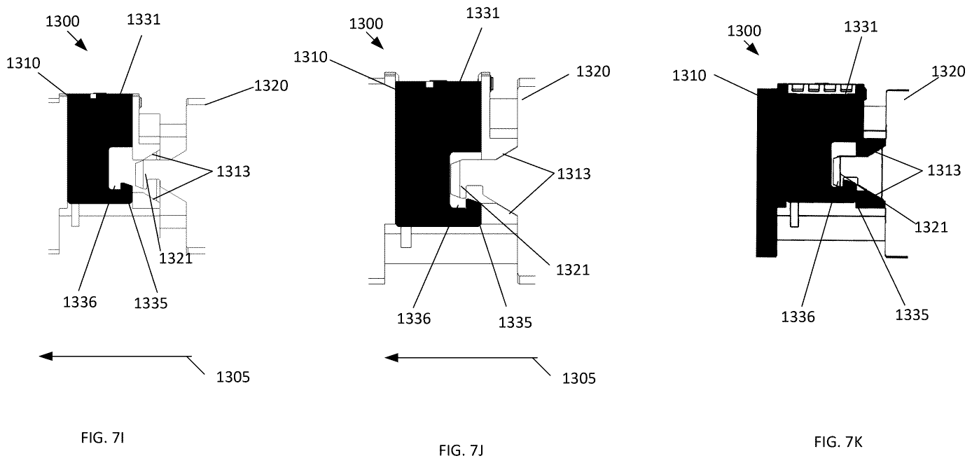

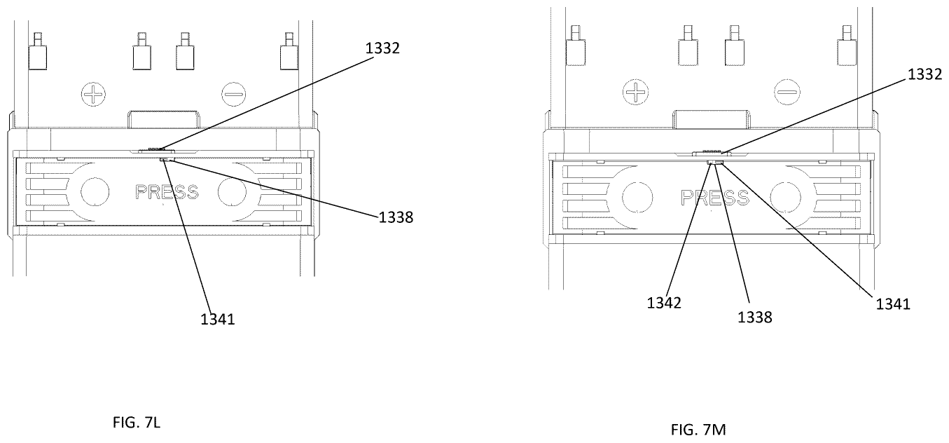

In other examples, a latch mechanism may automatically latch when mating connectors are pressed together. Such a latch mechanism may include an actuator that a user may press to release the latch. FIG. 7A illustrates a high current electrical connection system with a latch having an actuator, according to some embodiments of the technology described herein. Such a latch mechanism 1330 may be used in connector with any of the connectors described herein. The electrical connection system 1300 includes multiple terminals and may have the same or similar internal components to those discussed with relation to electrical connection system 700 (FIGS. 1-3D).

Electrical connection system 1300 includes plug 1310 and receptacle 1320. Latch mechanism 1330 is provided on the plug 1310 and interacts with features of the receptacle connector 1320 to secure the plug and receptacle connectors together and maintain electrical connections between them.

FIG. 7B is a view of a connection process of the high current electrical connection system of FIG. 7A, showing plug 1310 and receptacle connector 1320 separated but aligned for mating. The latch mechanism 1330 may be engaged by moving plug 1310 towards receptacle in insertion direction 1305. Hooked protrusion 1321 on the housing of the receptacle may engage with components of the latch mechanism 1330 to secure the receptacle and plug together. The latch mechanism 1330 may automatically engage when the plug 1310 is moved towards the receptacle 1320. The latch mechanism 1330 may be disengaged by pressing on the actuator 1331, allowing the plug 1310 and receptacle 1320 portions to be separated.

FIG. 7C is a view of the receptacle connector of the high current electrical connection system of FIG. 7A. The receptacle 1320 includes hooked protrusion 1321. The hooked protrusion 1321 may engage with features of the latch mechanism as the plug 1310 is inserted into the receptacle 1320. While only hooked protrusion 1321 is visible in FIG. 7C, the receptacle connector may include a second hooked protrusion opposite the first hooked protrusion 1321, on the side of the receptacle 1320, not visible in FIG. 7C.

The receptacle 1320 additionally includes notch 1322 which allows a user of the electrical connection system 1300 to access and move a locking feature 1332 of the latch mechanism 1330.

FIG. 7D is a view of the plug connector of the high current electrical connection system of FIG. 7A. The housing of the plug connector includes channels 1311 which are shaped to receive hooked protrusions of the receptacle connector.

Also shown in FIG. 7D is actuator 1331 and locking feature 1332. In the example illustrated, locking feature 1332 is mounted within a slot in the mating face of the plug housing such that it may slide within the slot. It may be moved between an engaged position and a disengaged position. In the engaged position, the locking feature 1332 may interfere with a portion of actuator 1331 to prevent the actuator 1331 from being pressed, thereby preventing plug 1310 and receptacle 1320 from being unlatched. In the disengaged position, locking feature 1332 may align with a channel in actuator 1331, such that actuator 1331 may be depressed, allowing the latch mechanism to be disengaged and the plug 1310 and receptacle 1320 portions to be separated. In some examples, the locking feature 1332 may be biased into the engaged position, such as by a spring, such that it automatically engages when the plug and receptacle connectors are connected.

Actuator 1331 may be biased into the undepressed, engaged position, such as by one or more springs. FIG. 7E is a view of springs of the plug connector of the high current electrical connection system of FIG. 7A that bias the actuator 1331 into the latched position. In this example, springs 1333 are provided on the top surface of the housing of the plug. The springs 1333 bias the actuator 1331 away from the top surface of the housing of the plug but may be compressed to enable the actuator to move towards the top surface of the plug 1310. The actuator 1331 is in a disengaged position when pressed towards the top surface of the plug 1310. The actuator is in an engaged position when biassed by the springs, away from the top surface of the plug 1310. The springs 1333 bias the actuator to move to the engaged position when the actuator is not pressed into the disengaged position.

FIG. 7F is a view of the housing of the plug connector of the high current electrical connection system of FIG. 7A. The springs are not visible in FIG. 7F. Spring positioning protrusions 1312 are provided on the top surface of the housing of the plug 1310. The spring positioning protrusions 1312 retain the springs 1333 on the top surface of the housing during use of the electrical connection system.

FIG. 7G is a view of the actuator of the high current electrical connection system of FIG. 7A. Actuator 1331 includes pushing surface 1334 and side portions extending perpendicularly from the pushing surface. The pushing surface includes a locking notch 1338. Each of the sides includes a hook 1335, opening 1336, and retaining protrusion 1337.

Pushing surface 1334 may be pressed by a user of the electrical connection system to disengage the latch mechanism, allowing the plug and receptacle to be separated. As can be seen, for example, in FIG. 7A, it is positioned for a user grasping the plug to easily press with a finger.

Hooks 1335 are shaped to engage with the hooked protrusions of the housing of the receptacle when the actuator is in the engaged position. The distal ends of the hooks are angled such that when hook 1335 presses against hooked protrusion 1321, actuator 1331 is forced downwards into a disengaged position. The distal ends of hooked protrusions 1321 may alternatively or additionally be tapered to generate such a downward force. As the plug is moved towards the receptacle, the angled portions of hooks 1335 contact the hooked protrusions, causing the actuator 1331 to move towards the top surface of the housing of the plug. In this state, the distal ends of hook 1335 may ride over the distal end of the hooked protrusion 1321 such that the tapered surface of hook 1335 slide past the tapered end of hooked protrusion 1321. The springs then bias the actuator to move away from the top surface of the housing, and the hooked protrusion may be retained within opening 1336.

Retaining protrusion 1337 may engage with the housing of the plug to retain the actuator 1331 at the housing.

Locking notch 1338 may engage with locking feature 1332. In the example, illustrated, licking notch 1332 includes a shallow portion and a deep portion. In this example, the deep portion extends through the entire thickness of a tope surface of the actuator and the shallow portion extends partially, but not entirely through the thickness of that surface. When locking feature 1332 aligns with the shallow portion, it interferes with downward motion of the actuator, establishing is in the engaged position. Conversely, when locking feature 1332 aligns with the deep portion, downward motion of the actuator is enabled, establishing a disengaged position. In this example, locking feature 1332 is positioned in a location that a user grasping the plug connector for mating or unmating can slide the locking feature into an engaged or disengaged position.

FIG. 7H is a side view of the latch of the high current electrical connection system of FIG. 7A with the plug and receptacle connected. In this example, opposing sides of the plug housing include channels into which the sides of the actuator 1331 extend. The channels are formed by side plates that are offset from other parallel surfaces of the plug housing to create a gap. The channel may be open at the top, enabling sides of the actuator to extend into the channel and may be open at a side facing the mating connector with an opening large enough to enable the hooked protrusion 1321 to extend into the channel to engage the actuator. Further, the channels may be deep enough or open at the bottom to enable the sides of the actuator to move downwards when the actuator is in the disengaged position without interfering with the bottom of the channel. In the state illustrated, retaining protrusion 1337 is shown engaged with the housing of the plug. The housing of the plug includes openings allowing the actuator to pass into channel 1311. The retaining protrusion 1337 may retain the actuator in the channel 1311 and prevent the actuator from being removed from the channel. In this example, the plates that form the channel include notches that engage protrusions from the mating connector when the connectors are properly aligned for mating, further facilitating reliable engagement.

FIGS. 7I-K are section views showing the latching mechanism of the high current electrical connection system of FIG. 7A during a mating process. The views of FIG. 7I-K are taken along line III-III in FIG. 7A. FIG. 7I shows the electrical connection system 1300 with the plug and receptacle connectors unmated. In FIG. 7I, the actuator is in the engaged position, however the plug 1310 of the electrical connection system 1300 is not fully inserted into the receptacle connector. The housing of the plug connector includes guiding edges 1313 which interact with the hooked protrusion 1321 of the receptacle connector 1320 to guide the plug as it is inserted into the channel 1311 of receptacle 1320, along insertion direction 1305.

In FIG. 7J, the plug connector 1310 has been moved towards receptacle connector 1320 along insertion direction 1305. The hooked protrusion 1321 of the receptacle connector contacts the edge of opening 1336 of the actuator 1331, causing the actuator to move down into the disengaged position.

In FIG. 7K, the hooked protrusion 1321 of the receptacle connector is beyond the distal end of distal ends of hook 1335, such that the force generated by interaction of those components is no longer applied and the springs have biassed the actuator 1331 to move to the engaged position. In this state, the hooked protrusion 1321 of the receptacle connector 1320 is contained within opening 1336 of the actuator, preventing the plug connector from being removed from the receptacle connector. In this state, a locking feature may be engaged, either by manual motion of the locking feature or automatically when the plug connector 1310 is inserted into the receptacle connector 1320.

The plug connector 1310 may be removed from the receptacle connector 1320 by pressing the actuator to the disengaged position, shown in position 1302, and moving the plug connector away from the receptacle connector 1320, in a direction opposite the insertion direction 1305.

FIG. 7L is a view of a locking feature of the high current electrical connection system of FIG. 7A, in an engaged position, which prevents the actuator from being pressed down. Therefore, when the plug connector is inserted into the receptacle connector, and the locking feature is in the engaged position, the plug connector and receptacle connector may be securely connected. In this state, a first prong 1341 is aligned with the deeper portion of the notch 1338 but a second prong 1342 is aligned with the shallow portion of the notch 1338, preventing the actuator from being depressed.

FIG. 7M is a view of a locking feature of the high current electrical connection system of FIG. 7A in a disengaged position in which the actuator may be pressed towards the top surface of the hosing of the plug. The actuator may be pressed because both first prong 1341 and second prong 1342 are aligned with the deeper portion of the locking notch, enabling the actuator to move towards the top surface of the housing. In contrast, in the engaged position, the second prong is beneath the actuator and prevents the actuator from being pressed towards the top surface of the housing. The locking feature 1332 may be slid by a user of the electrical connection system between the engaged and disengaged positions. In some examples, the locking feature may automatically engage when the receptacle and plug connectors of the electrical connection system are connected.

Either or both of first prong 1341 and second prong 1342 may be configured to provide a visual indicator of the locking feature being engaged or disengaged. The prongs may be colored differently, for example, or second prong 1342 may be brightly colored. In the engaged position, first prong 1342 but not second prong 1342 is visible through notch 1338 In the disengaged position, both prongs are visible through the notch 1338. In some examples, only second prong 1342 may be present or colored for providing a visual indicator of locking.

In some examples, connectors as described herein may use retention members to retain terminal subassemblies such that the terminal subassemblies may be easily installed or removed from a housing, enabling the terminal subassemblies and/or the housing to be easily replaced, even in the field. FIG. 8A is an exploded view of a receptacle connector of a high current electrical connection system, according to some embodiments of the technology described herein. The receptacle connector of FIGS. 8A-G is that of an electrical connection system with multiple terminals and a push actuator locking system, such as that of FIGS. 7A-I, however, it should be appreciated that the features of receptacle 1320 may be used in other connection systems, such as those discussed with reference to FIGS. 1-2 and 5.

Receptacle 1320 includes four retaining members 1410A-D, each retaining member having a respective elongate portion 1411A-D and compliant portion 1412A-D. The retaining members 1410A-D are configured to fit within respective holes 1421A-D in housing 1420. While four retaining members are shown in FIG. 8A. In this example, retaining members engage each of two opposing sides of each terminal assembly. The retaining members are inserted into the housing so that each retaining member engages multiple terminal assemblies, such that a total of four retaining members retain four terminal assemblies. However, greater or fewer retaining members may be used, depending on the arrangement of the components of the receptacle connector, for example, one retaining member, two retaining members, three retaining members, five retaining members, six retaining members, seven retaining members, eight retaining members, or greater than eight retaining members may be used.

When inserted into respective holes 1421A-D, retaining members 1410A-D secure terminals within the housing 1420.

FIG. 8B is a view of the bottom wall of the receptacle of the high current electrical connection system of FIG. 8A. The bottom wall of the housing 1420 includes bottom holes 1422A-D. The retaining members may pass through the height of the housing and engage with bottom holes in the bottom wall of the housing. The bottom holes 1422A-D may limit the movement of the retaining members 1410A-D in a plane parallel to the bottom wall, ensuring the retaining members are properly positioned to retain the terminal assemblies within the housing. In some scenarios, holes may also facilitate removal of the retaining members such that terminal assemblies may be removed from the connector housing. Alternatively or additionally, in some examples, the housing may include features on the bottom surface of the interior of the housing which limit the movement of the retaining members.

FIG. 8C is a section view of the receptacle connector of the high current electrical connection system of FIG. 8A. The view of FIG. 8C is taken along line V-V in FIG. 7C. Retaining member 1410A is shown in FIG. 8C and retaining members 1410B-D may include the same features and function as described with reference to retaining member 1410A. Retaining member 1410A is shown inserted through hole 1421A in the top wall 1423 of the housing and bottom hole 1422A in the bottom wall 1424 of the housing. During insertion of the retaining member, the compliant portion 1412A may contact the edge of hole 1421A in the top wall of the housing, and bend towards elongate portion 1411A. When the retaining portion is fully inserted into the housing, the compliant portion may move to its original position and be secured against the interior surface of the top wall of the housing, as shown in FIG. 8C. The compliant portion may be bent by a user of the receptacle 1320, with an object such as a finger or a tool, allowing the retaining member 1410 to be removed from the housing through the hole 1421. A suitable tool may be long and thin, such as a screwdriver or similarly shaped tool, and may be readily available to a worker in the field maintaining an electrical connection system including receptacle connector 1320.

When inserted into the housing 1420, the retaining member 1410A engages with the terminals and secures the terminals within the housing. The retaining members may engage with tabs, notches or other features of the terminals, such as is shown, for example in FIG. 3C.

FIG. 8D is a section view of the housing of the receptacle connector of the high current electrical connection system of FIG. 8A. The view of FIG. 8D is taken along line VI-VI in FIG. 8B. The housing 1420 includes retaining protrusions 1425 which align with holes 1421 and guide the insertion of retaining members into the housing 1420. The retaining protrusions 1425 may secure the retaining members in a position within the housing, such that when the retaining members are inserted they interact with the terminals and secure the terminals within the housing.

Housing 1420 additionally includes terminal slots 1426 which guide the placement of terminals within the housing. The terminal slots 1426 include alignment channels 1427 for positioning the terminals within the housing. When the terminals are properly placed within the housing, the terminal slots and retaining members may secure the terminals within the housing, preventing them from being removed and ensuring proper functioning of the receptacle connector 1320 for making electrical connections.

FIG. 8E is a top view of terminal assemblies of the receptacle of the high current electrical connection system of FIG. 8A. Terminals assemblies 1430 include positioning notches 1431 which engage with elongate portions of retaining members 1410. Protrusions 1432 may be inserted into the alignment channels 1427 of the housing 1420, such that when properly inserted, the terminals are secured within the terminal slots and the retaining members 1410. As shown, each retaining member 1410 engages with positioning notches on one side of each terminal assembly 1430, however in some examples, retaining members 1410 may engage with multiple sides of terminals, for example multiple adjacent terminal assemblies may engage with a single retaining member.

FIG. 8F is a side view of the terminal assemblies of the receptacle connector of the receptacle connector of the high current electrical connection system of FIG. 8A. The terminal assemblies may be retained by the retaining members. As shown, the retaining member 1410A engages with two terminal assemblies 1430. In some examples, retaining members may engage with greater or fewer terminal assemblies, for example, one terminal, three terminal assemblies, four terminal assemblies, five terminal assemblies, six terminal assemblies, seven terminal assemblies, eight terminal assemblies or greater than eight terminal assemblies.

FIG. 8G is a view of an assembly process of the receptacle of the high current electrical connection system of FIG. 8A. To assemble the receptacle 1320, the terminal assemblies are moved in insertion direction 1405 into the housing 1420 through the opening in the rear of the housing. Once the terminal assemblies have been inserted into the housing, the retaining members 1410A-D are inserted into holes 1421A-D in the housing, in insertion direction 1406. When properly inserted into holes 1421A-D, the compliant portions of the retaining members may engage and secure the retaining members against the interior surface of the top wall of the housing, blocking withdrawal of the retaining members. When inserted into the housing, the retaining members interact with the terminal assemblies to secure the terminal assemblies within the housing.

The receptacle 1320 may be disassembled by first removing the retaining members 1410A-D from the housing, in the direction opposite insertion direction 1406. After the retaining members 1410A-D have been removed from the housing, the terminal assemblies 1430 may be removed from the housing through the opening in the rear of the housing, in a direction opposite direction 1405. The compliant portions may be bent towards the elongate portions of the retaining members 1410A-D, in order to remove the retaining members from the housing 1420. The compliant portions may be bent with an object such as a finger or tool. The receptacle connector may be disassembled to repair or replace one or more terminals, the housing, or other components of the receptacle connector.

A plug connector may include retaining members, which may be the same or different than those used in the receptacle connector. FIG. 9A is an exploded view of the plug of a high current electrical connection system, according to some embodiments of the technology described herein. The plug 1310 of FIGS. 9A-G is that of FIGS. 7A-I, however, it should be appreciated that the retaining members and other features of plug 1310 may be used in other connection systems, such as those discussed with reference to FIGS. 1, 3 and 6.

Plug 1310 includes four retaining members 1510A-D, each retaining member having a respective elongate portion 1511A-D and compliant portion 1512A-D. The retaining members 1510A-D are configured to fit within respective holes 1521A-D in housing 1520. While four retaining members are shown in FIG. 9A, greater or fewer retaining members may be used, depending on the arrangement of the components of the plug connector, for example, one retaining member, two retaining members, three retaining members, five retaining members, six retaining members, seven retaining members, eight retaining members, or greater than eight retaining members may be used.

When inserted into respective holes 1521A-D, retaining members 1510A-D secure terminal assemblies within the housing 1520.

FIG. 9B is a view of a bottom surface of the plug connector of the high current electrical connections system of FIG. 9A. The bottom wall of the housing 1520 includes bottom holes 1522A-D, which may function as described above for holes 1422A-1422D. In some examples, the housing may include features on the bottom surface of the interior of the housing which limit the movement of the retaining members.

FIG. 9C is a section view of the plug of the high current electrical connections system of FIG. 9A. The view of FIG. 9C is taken along line VII-VII in FIG. 9B. Retaining member 1510A is shown in FIG. 9C and retaining members 1510B-D may include the same features and function as described with reference to retaining member 1510A. Retaining member 1510A may have the features and functions described above in connection with retaining member 1410A.

Retaining member 1510A is shown inserted through hole 1521A in the top wall 1523 of the housing and bottom hole 1522A in the bottom wall 1524 of the housing. During insertion of the retaining member, the compliant portion 1512A may contact the edge of hole 1521A in the top wall of the housing, and bend towards elongate portion 1511A. When the retaining portion is fully inserted into the housing, the compliant portion may move to its original position and be secured against the interior surface of the top wall of the housing, as shown in FIG. 9C. The compliant portion may be bent by a user of the plug 1310, with an object such as a finger or a tool, allowing the retaining member 1510A to be removed from the housing through the hole 1521A.

When inserted into the housing 1520, the retaining member 1510A engages with the terminal assemblies and secures the terminals within the housing.

FIG. 9D is a section view of the housing of the plug connector of the high current electrical connections system of FIG. 9A. The view of FIG. 9D is taken along line VIII-VIII in FIG. 9B. The housing 1520 includes retaining protrusions 1525 which align with holes 1521 and guide the insertion of retaining members into the housing 1520. The retaining protrusions 1525 may secure the retaining members in place within the housing, such that when the retaining members are inserted they interact with the terminals and secure the terminals within the housing. Housing 1520 additionally includes terminal slots 1526 which guide the placement of terminal assemblies within the housing. The terminal slots 1526 include alignment channels 1527 for positioning the terminal assemblies within the housing. When the terminal assemblies are properly placed within the housing, the terminal slots and retaining members may secure the terminal assemblies within the housing, preventing them from being removed and ensuring proper functioning of the plug 1310 for making electrical connections.

FIG. 9E is a top view of terminal assemblies of the plug of the high current electrical connections system of FIG. 9A. Terminals 1530 include positioning notches 1531 which engage with elongate portions of retaining members 1510. Protrusions 1532 may be inserted into the alignment channels 1527 of the housing 1520, such that when properly inserted, the terminal assemblies are secured within the terminal slots and the retaining members 1510. As shown, each retaining member 1510 engages with positioning notches on one side of each terminal assembly 1530, however in some examples, retaining members 1510 may engage with multiple sides of terminals, for example multiple adjacent terminals may engage with a single retaining member.

FIG. 9F is a side view of terminal assemblies of the portion of the high current electrical connections system of FIG. 9A. The terminal assemblies may be retained by the retaining members. As shown, the retaining member 1510A engages with two terminal assemblies 1530. In some examples, retaining members may engage with greater or fewer terminal assemblies, for example, one terminal assembly, three terminal assemblies, four terminal assemblies, five terminal assemblies, six terminal assemblies, seven terminal assemblies, eight terminal assemblies or greater than eight terminal assemblies.

FIG. 9G is a view of an assembly process of the plug of the high current electrical connections system of FIG. 9A. To assemble the plug 1310, the terminal assemblies are moved in insertion direction 1505 into the housing 1520 through the opening in the rear of the housing. Once the terminal assemblies have been inserted into the housing, the retaining members 1510A-D are inserted into holes 1521A-D in the housing in insertion direction 1506. When properly inserted into holes 1521A-D, the compliant portions of the retaining members may engage and secure the retaining members against the interior surface of the top wall of the housing. The retaining members may also retain the terminals within the housing.

The plug 1310 may be disassembled by first removing the retaining members 1510A-D from the housing, in the direction opposite insertion direction 1506. After the retaining members 1510A-D have been removed from the housing, the terminal assemblies 1530 may be removed from the housing through the opening in the rear of the housing in a direction opposite direction 1505. The compliant portions may be bent towards the elongate portions of the retaining members 1510A-D, in order to remove the retaining members from the housing 1520. The compliant portions may be bent with an object such as a finger or tool to enable removal of the retaining portions. The plug may be disassembled to repair or replace one or more terminals, the housing, or other components.

FIG. 10A is a section view of signal conductors of a plug connector, according to some aspects of the technology described herein. The view of FIG. 10A is taken along line IX-IX in FIG. 7A and depicts electrical connection system 1300. In this illustration, actuator 1331 and springs 1333 are not present. Other electrical connection systems as described herein, such as the electrical connection system shown in FIGS. 1-6D may include the same or similar signal conductor assemblies and operate in the same way as described with reference to FIGS. 10A-G. The electrical connection system 1300 of FIGS. 10A-G is a connection system with multiple terminals and a push actuator latch mechanism, however, signal conductors may be included in other electrical connection systems, such as connectors with other types of latching and locking mechanisms as described herein.

As shown, the plug connector 1310 includes signal conductor assembly 1620 which is separable from but can be removably latched within housing 1520. The signal conductor assembly 1620 includes signal conductors 1622. In this example, each of the signal conductors may be connected to a wire, which may extend from the rear of the connector housing.

Signal conductor assembly 1620 includes carrier 1621 and conductors 1622. A retention mechanism may be used to hold the signal conductors in the carrier. In some examples, the retention mechanism enables the signal conductors to be removed and/or easily installed in the carrier. Examples of retention mechanisms include barbs, adhesive, and interference fit.

Signal conductors 1622 terminate in mating contact portions, which in this example are shaped as receptacles configured to receive complementary mating contact portions of signal conductors of a mating connector (e.g. pins 1672, FIG. 10B). Signal conductors 1622 protrude outside of carrier 1621 into a signal conductor protrusion 1642, which may function as and may alternatively or additionally be shaped and otherwise constructed as signal conductor protrusion 912, described above. Signal conductor protrusion 1642 may be molded as part of the housing 1520 and in this example has holes 1646 corresponding to the locations of the signal conductors 1622. Mating contact portions of signal conductors (e.g. pins 1672) may pass through holes 1646 to mate with signal conductors 1622.

Singal conductors may similarly be mounted in a receptacle connector with a signal conductor assembly. FIG. 10B is a section view of signal conductors of the receptacle connector of the high current electrical connection system of FIG. 10A. The view of FIG. 10B is taken along line X-X in FIG. 7C. As shown, the signal conductor assembly 1610 includes carrier 1611, and conductors 1612. As with signal conductor assembly 1620, the signal conductors of the receptacle connector may be terminated to wires and may have mating contact portions. Mating contact portions of conductors 1612, here shaped as pins 1672, extend beyond the carrier. In this example, pins 1672 extend into a cavity 1682. Cavity 1682 may function like cavity 813 described above and alternatively or additionally may have the same shape or construction as cavity 813. Cavity 1682, for example, may receive signal conductor protrusion 1642 from a mating connector. In this example, cavity 1682 is recessed into a surface of the receptacle connector housing 1420.

Carriers 1611 and 1621 are configured for insertion and removal into their respective connector housings. This capability is described in connection with carrier 1611 as shown in FIG. 10B, but a similar description applies to carrier 1621.

Carrier 1611 includes compliant portions 1613 extending from opposing sides of a based with holes 1618 in which signal conductors are mounted. Compliant portions 1613 include chamfered protrusions 1614 and end protrusions 1615. Chamfered protrusions 1614 engage with edges 1633 of the housing 1420. The compliant portions 1613 may be deflected towards each other during insertion or removal of the signal conductor assembly 1610 from the connector housing. As signal conductor assembly 1610 is inserted into channel 1634 of housing 1420, edges 1633 may contact the chamfered protrusions as the signal conductor is moved towards the mating face 1635 of the housing, causing the chamfered protrusions to move towards each other. When the chamfered protrusions have moved past edges 1633, the compliant portions may spring back to their original positions, securing the signal conductor assembly within the housing 1420.

For removal, the compliant portions 1613 may be moved towards each other, such as by a user pressing on end protrusions 1615 with an object such as their fingers or a tool. The chamfered protrusions 1614 may then be disengaged from the edges 1633 and the signal conductor assembly may be removed from the housing 1420 by moving it away from mating face 1635. The signal conductor assembly may be removed to repair or replace the assembly or to repair or replace one or more other components of the signal conductors of the assembly.

While the plug connector is shown with a protrusion surrounding the signal conductors, and the receptacle connector is shown with a cavity surrounding the signal conductors, it should be appreciated that this positioning may be reversed. The plug connector may include a cavity and signal conductors disposed within the cavity, and the receptacle connector may include a protrusion with signal conductors.

FIG. 10C is a sectional view of signal conductors of the plug connector 1310 of FIG. 10A. The view of FIG. 10C is taken along line XI-XI in FIG. 7D. As shown the signal conductor assembly 1620 includes carrier 1621 and conductors 1622. The carrier 1621 includes compliant portions 1623. Compliant portions 1623 include chamfered protrusions 1624 and end protrusions 1625. Chamfered protrusions 1624 engage with edges 1643 of the housing 1520. The compliant portions 1623 may be deflected towards each other during insertion or removal of the signal conductor assembly 1620. During insertion, the edges 1643 may contact the chamfered protrusions as the signal conductor assembly is moved towards the mating face 1645, causing the chamfered protrusions to move towards each other, when signal conductor assembly 1620 is inserted into channel 1644 of housing 1520. When the chamfered protrusions have moved past edges 1643, the compliant portions may spring back to their original positions, securing the signal conductor assembly within the housing 1520.

During removal, the compliant portions 1623 may be moved towards each other by pressing on end protrusions 1625 with an object such as fingers or a tool. The chamfered protrusions 1624 may then be disengaged from the edges 1643 and the signal conductor assembly may be removed from the housing 1520 by moving it away from opening 1645. The signal conductor assembly may be removed to repair or replace the assembly or to repair or replace one or more other components of the plug connector.

FIG. 10D is a view of the signal conductors of the receptacle of the high current electrical connection system of FIG. 10B or 10C. The signal conductor assembly 1610 includes carrier 1611, signal conductors 1612, compliant portions 1613, chamfered protrusions 1614, end protrusions 1615, wires 1616, projections 1617, and holes 1618. In this example, carrier 1611 may be formed of an insulative material. It may be formed, for example, by molding of a thermoplastic, nylon or other similar material. The signal conductors may be formed of a conductive material, such as a copper alloy.

The signal conductors 1612 are attached to wires 1616, which may be attached to one or more electrical components. The signal conductors may be assembled into carrier by inserting the conductors into respective holes 1618, through the side of the carrier opposite projections 1617. Such a configuration enables the signal conductors to be inserted into the carrier after being terminated to respective wires.

Projections 1617 may be provided to position the signal conductor assembly within the housing of the receptacle. For example, the projections 1617 may engage with one or more features of the housing during an insertion process to guide and/or position the signal conductor assembly 1610.

FIG. 10E shows the signal conductors of the plug connector of FIG. 10A. The signal conductor assembly 1620 includes carrier 1621, signal conductors 1622, compliant portions 1623, chamfered protrusions 1624, end protrusions 1625, wires 1626, and holes 1627. materials and construction techniques as used for signal conductor assembly 1610 may be used for signal conductor assembly 1620.

The signal conductors 1622 are attached to wires 1626, which may be attached to one or more electrical components. The signal conductors may be assembled into carrier by inserting the conductors into respective holes, through the side of the carrier 1621 on the same side that the wires exit. This allows the signal conductors to be installed in to carrier 1621 after being terminated to wires.

FIG. 10F is a view of an insertion process of the signal conductor assembly of the receptacle connector of the high current electrical connection system of FIG. 10A or 10C. The signal conductor assembly 1610 may be moved in insertion direction 1605 into channel 1634 of the housing 1420. The compliant portions may deflect when chamfered protrusions 1614 contact the housing 1420, causing the carrier 1611 to engage with the housing, such that the signal conductor assembly is retained within the housing.

The signal conductor assembly may be removed from the housing by bending the compliant portions 1613 towards each other, and moving the signal conductor assembly 1610 in a direction opposite to insertion direction 1605.

FIG. 10G is a view of an insertion process of the signal conductor assembly of the plug connector of the high current electrical connection system of FIG. 10B. The signal conductor assembly 1620 may be moved in insertion direction 1606 into channel 1644 of the housing 1420. The compliant portions may deflect when chamfered protrusions 1624 contact the housing 1420, causing the carrier 1621 to engage within the housing, such that the signal conductor assembly is retained within the housing.

The signal conductor assembly may be removed from the housing by bending the compliant portions 1623 towards each other, and moving the signal conductor assembly 1620 in a direction opposite to insertion direction 1606.

Having thus described several aspects of at least one embodiment of the technology described herein, it is to be appreciated that various alterations, modifications, and improvements will readily occur to those skilled in the art. Such alterations, modifications, and improvements are intended to be part of this disclosure and are intended to be within the spirit and scope of disclosure. Further, though advantages of the technology described herein are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The terms “approximately” and “about” may be used to mean within ±20% of a target value in some embodiments, within ±10% of a target value in some embodiments, within ±5% of a target value in some embodiments, within ±2% of a target value in some embodiments. The terms “approximately” and “about” may include the target value.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

1. An electrical connector configured to support a high current, the electrical connector comprising:
an electrically conductive terminal configured as a power terminal and comprising a mating portion;
an insulative housing comprising:
a cavity;
a first wall bounding the cavity, the first wall comprising a first hole;
a first opening into the cavity, the first opening sized for the electrically conductive terminal to pass through the first opening into the cavity during assembly; and
a second opening into the cavity, wherein the mating portion of the electrically conductive terminal is disposed within the cavity and accessible through the second opening; and
a signal conductor assembly comprising a plurality of signal terminals and a signal conductor carrier supporting the plurality of signal terminals, wherein the signal conductor carrier comprises a compliant portion configured to engage with a feature of the insulative housing.

2. The connector of claim 1, wherein:
the second opening is in a mating face of the insulative housing;
the signal terminals comprise mating portions; and
the feature of the insulative housing is configured to engage with the compliant portion of the signal conductor carrier to support the signal conductor assembly in a position in which the mating portions of the plurality of signal terminals are exposed through a respective plurality of openings in the mating face of the insulative housing.

3. The connector of claim 2, wherein:
the position in which the mating portions of the plurality of signal terminals are exposed through a respective plurality of openings in the mating face of the insulative housing is within the cavity; and
the first opening of the insulative housing is configured for the signal conductor assembly to be inserted into the cavity therethrough.

4. The connector of claim 3, wherein the compliant portion of the signal conductor assembly comprises a tab configured to extend into the cavity when the compliant portion is engaged with the feature of the insulative housing such that the compliant portion can be disengaged from the feature of the insulative housing for removal of the signal conductor assembly from the insulative housing.

5. The connector of claim 1, comprising:
a plurality of electrically conductive terminals configured as power terminals, wherein:
the plurality of electrically conductive terminals comprising the electrically conductive terminal;
the signal conductor assembly is disposed within the cavity of the insulative housing between a first group of the plurality of electrically conductive terminals and a second group of the plurality of electrically conductive terminals.

6-39. (canceled)

40. A first electrical connector configured to support a high current and configured to mate with a second electrical connector comprising hooked protrusions, the first electrical connector comprising:
a plurality of electrically conductive terminals;
an insulative housing comprising:
a mating interface comprising a plurality of openings exposing respective ends of the plurality of electrically conductive terminals; and
a first and a second channel positioned on a respective first and second side of the mating interface, configured to receive the hooked protrusions of the second electrical connector; and
a latch configured to secure the first connector to the second connector, comprising:
an actuator slidably mounted to the insulative housing, the actuator comprising first and second hooks positioned within the first and second channels; and
a spring between the actuator and the insulative housing, the spring biasing the actuator away from a surface of the insulative housing.

41. The first electrical connector of claim 40, wherein the actuator is configured to move towards the surface of the insulative housing when the hooked protrusions of the second connector enter the first and second channels.

42. The first electrical connector of claim 40, further comprising a locking feature configured to move between an engaged and disengaged position and configured to restrict movement of the actuator when in the engaged position.

43. The first electrical connector of claim 42, wherein the locking feature is configured to move to the engaged position when the first connector is mated to the second connector.

44. The first electrical connector of claim 42, wherein the locking feature is configured to be manually disengaged.

45. The first electrical connector of claim 42, wherein the locking feature comprises a visual indicator, which is in a first position when the locking feature is engaged and is in a second position when the locking feature is not engaged.

46. The first electrical connector of claim 40, wherein the first and second hooks are configured to be disengaged from the hooked protrusions when the actuator is moved towards the surface of the insulative housing.

47. The first electrical connector of claim 40, wherein the first and second hooks comprise respective angled portions bounding respective openings, the angled portions configured to contact the hooked protrusions of the second electrical connector and move the actuator towards the surface of the insulative housing when in contact with the hooked protrusions of the second connector.

48. The first electrical connector of claim 47, wherein the openings of the first and second hooks are configured to receive the hooked protrusions of the second connector.

49. A first electrical connector configured support a high current and configured to mate with a second electrical connector comprising an exterior protrusion comprising a first portion and a second portion, wider than the first portion, the first electrical connector comprising:
a first electrically conductive terminal; and
a first insulative housing comprising:
a first mating interface comprising a first opening exposing an end of the electrically conductive terminal; and
a latch rotatably coupled to the housing and configured to rotate between a first position and a second position, the latch comprising:
a first end comprising a race with an opening into the race and a second end comprising an actuator, wherein the latch is rotatably coupled to the housing between the first end and the second end of the latch, wherein the latch is configured such that when the first connector and second connector are pushed together with the latch in the first position, the second portion of the exterior protrusion of the second connector is aligned with the opening into the race.

50. The first connector of claim 49, wherein rotation of the latch from the first position to the second position urges the first and second connectors together.

51. The first connector of claim 49, wherein the first electrically conductive terminal comprises a planar blade.

52. The first connector of claim 49, further comprising a plurality of signal conductors configured to connect to a respective plurality of signal conductors of the second connector, when the latch is in the second position with the exterior protrusion within the race.

53. The first connector of claim 49, further comprising a first cable terminated to the first electrically conductive terminal.

54. The first connector of claim 49, wherein the latch further comprises a locking feature configured to secure the latch, when the latch is rotated to the second position.

55. The first connector of claim 54, wherein the locking feature comprises a slider and a channel, and wherein the slider is configured to move through the channel into an aperture of the first insulative housing when the latch is rotated to the second position.

56. The first connector of claim 55, wherein:
the slider comprises a compliant arm deflectable from a first state in which the arm abuts a structure that interferes with motion of the slider in at least one direction within the channel and a second state in which the arm does not interfere with motion of the slider in the at least one direction within the channel; and
the first insulative housing comprises a projection aligned with a portion of the compliant arm and configured to urge the compliant arm into the second state when the latch is rotated into the second position.

57. The first connector of claim 55, wherein the locking feature of the comprises a spring configured to bias the slider towards an end of the channel closest to the aperture when the latch is in the second position.

58. The first connector of claim 55, wherein the first insulative housing comprises a protrusion configured to enter the channel of the locking feature when the latch is in the second position and move the slider into the aperture.

59. The first connector of claim 55, wherein the locking feature comprises a visual indicator, wherein the visual indicator is in a first position when the locking feature is engaged with the aperture and the visual indicator is in a second position when the locking feature is not engaged with the aperture.

60. The first connector of claim 54, wherein the locking feature is configured to be manually disengaged.

61. The first connector of claim 49, wherein the first position of the latch is approximately at a right angle to the second position of the latch.

62-64. (canceled)
